(19) United States
(12) Patent Application Publication
(10) Pub. No.: US 2023/0370237 A1
(43) Pub. Date: Nov. 16, 2023

(54) COMMUNICATION APPARATUS AND COMMUNICATION METHOD FOR MULTIPLE ACCESS POINT BASED NULL DATA PACKET FEEDBACK REPORT

(71) Applicant: Panasonic Intellectual Property Corporation of America, Torrance, CA (US)

(72) Inventors: Yanyi DING, Singapore (SG); Lei HUANG, Singapore (SG); Yoshio URABE, Nara (JP); Rojan CHITRAKAR, Singapore (SG)

(21) Appl. No.: 18/042,736

(22) PCT Filed: Jun. 3, 2021
(86) PCT No.: PCT/SG2021/050320

§ 371 Date: Feb. 23, 2023

(30) Foreign Application Priority Data
Aug. 28, 2020 (SG) 10202008336W

(51) Int. Cl. H04L 5/00; H04B 7/0417

(52) U.S. Cl. CPC H04L 5/0094; H04B 7/0417

(57) ABSTRACT

The present disclosure provides a communication apparatus comprising: circuity, which, in operation, generates a first frame to initiate a null data packet (NDP) feedback report procedure; and a transmitter, which, in operation, transmits the first frame to one or more peer communication apparatuses, wherein the first frame comprises a first field indicating an intended type of NDP feedback report procedure.

### TECHNICAL FIELD

The present disclosure relates to communication apparatuses and methods for null data packet (NDP) feedback report, and more particularly to communication apparatuses and methods for multiple access point based NDP feedback report in EHT WLAN (extremely high throughput wireless local area network).

### BACKGROUND

In the standardization of next generation wireless local area network (WLAN), a new radio access technology necessarily having backward compatibilities with IEEE 802.11a/b/g/n/ac/ax technologies has been discussed in the IEEE 802.11 Working Group and is named IEEE 802.11be Extremely High Throughput (EHT) WLAN.

In 802.11be EHT WLAN, in order to provide significant peak throughput and capacity increase beyond 802.11ax high efficiency (HE) WLAN, especially for cell-edge STAs, it has been proposed to enable multiple access point (multi-AP) coordination in a multi-AP system.

However, there has been no much discussion on efficient procedure for multi-AP based NDP feedback report.

There is thus a need for communication apparatuses and methods that provide feasible technical solutions for multi-AP based NDP feedback report in the context of EHT WLAN. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for multi-AP based NDP feedback report in context of EHT WLAN.

In a first aspect, the present disclosure provides a communication apparatus comprising: circuitry, which, in operation, generates a first frame to initiate a null data packet (NDP) feedback report procedure; and a transmitter, which, in operation, transmits the first frame to one or more peer communication apparatuses, wherein the first frame comprises a first field indicating an intended type of NDP feedback report procedure.

In a second aspect, the present disclosure provides a peer communication apparatus comprising: a receiver, which, in operation, receives a first frame from a communication apparatus to initiate a NDP feedback report procedure; and circuitry, which, in operation, processes the first frame, wherein the first frame comprises a first field which indicates an intended type of NDP feedback report procedure.

In a third aspect, the present disclosure provides a communication method comprising: generating a first frame to initiate a NDP feedback report procedure, wherein the first frame comprises a first field indicating an intended type of NDP feedback report procedure; and transmitting the first frame to one or more peer communication apparatuses.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1A depicts a schematic diagram of uplink and downlink single-user (SU) multiple input multiple output (MIMO) communication between an access point (AP) and a station (STA) in a MIMO wireless network.

FIG. 1B depicts a schematic diagram of downlink multi-user (MU) communication between an AP and multiple STAs in a MIMO wireless network.

FIG. 1C depicts a schematic diagram of trigger-based uplink MU communication between an AP and multiple STAs in a MIMO wireless network.

FIG. 1D depicts a schematic diagram of trigger-based downlink multi-AP communication between multiple APs and a STA in a MIMO wireless network.

FIG. 2A shows a flow diagram illustrating communications of a 802.11ax single-AP (access point) based null data packet (NDP) feedback report procedure.

FIG. 2B shows an example format of a high efficiency (HE) trigger-based (TB) Feedback NDP.

FIG. 3 shows a flow diagram illustrating communications of a sequential multi-AP based NDP feedback report procedure according to an embodiment.

FIG. 4 shows a flow diagram illustrating communications of a joint multi-AP based NDP feedback report procedure according to another embodiment.

FIG. 5A shows an example format of a multi-AP (MAP) Announcement frame.

FIG. 5B shows an AP Info field of the MAP Announcement frame according to an embodiment.

FIG. 6A shows an example format of an extremely high throughput (EHT) Trigger frame.

FIG. 6B shows an example format of a Common Info field of an EHT Trigger frame.

FIG. 6C shows an example format of a User Info field of an EHT Trigger frame.

FIG. 7 shows an example format of a Common Info field of an EHT Single-AP based NDP Feedback Report Poll (EHT SB NFRP) Trigger frame.

FIG. 8 shows an example of a User Info field of an EHT SB NFRP Trigger frame.

FIG. 9 shows an example format of an EHT TB Feedback NDP.

FIGS. 10A-10B show two example frequency domain representations of EHT-LTF (long training field) symbols in a 20 MHz EHT TB Feedback NDP according to an embodiment.

FIG. 11 shows a schematic example of communication apparatus in accordance with various embodiments. The communication apparatus may be implemented as an access point (AP) or a station (STA) and configured for multiple access point based NDP feedback report in accordance with the present disclosure.

FIG. 12 shows a flow diagram illustrating a communication method according to the present disclosure.

FIG. 13 shows an example STA specific tone group formation in a 40 MHz EHT TB Feedback NDP according to a first embodiment of the present disclosure.

FIG. 14 shows an example format of a Common Info field of an EHT Multi-AP based NFRP (EHT MB NFRP) Trigger frame according to the first embodiment.

FIG. 15 shows an example format of a User Info field of an EHT MB NFRP Trigger frame according to the first embodiment.

FIG. 16 shows an example format of a BSS Specific Tone Group Indication subfield of a User Info field in an EHT MB NFRP Trigger frame according to the first embodiment.

FIG. 17 shows another example format of a Common Info field of an EHT MB NFRP Trigger frame according to the first embodiment.

FIG. 18 shows another example format of a BSS Specific Tone Indication subfield of a Common Info field in an EHT MB NFRP Trigger frame according to the first embodiment.

FIG. 19 shows another example format of a User Info field of an EHT MB NFRP Trigger frame according to the first embodiment.

FIG. 20 shows a STA specific tone group index according to a second embodiment of the present disclosure.

FIG. 21 shows an example format of a Common Info field of an EHT MB NFRP Trigger frame according to the second embodiment.

FIG. 22 shows an example format of a User Info field of an EHT MB NFRP Trigger frame according to the second embodiment.

FIG. 23 shows an example format of a BSS Specific Tone Group Indication subfield of the User Info field in an EHT MB NFRP Trigger frame according to the second embodiment.

FIG. 24 shows another example format of a Common Info field of an EHT MB NFRP Trigger frame according to the second embodiment.

FIG. 25 shows another example format of BSS Specific Tone Group Indication subfield of a Common Info field in an EHT MB NFRP Trigger frame according to the second embodiment.

FIG. 26 shows another example format of a User Info field of an EHT MB NFRP Trigger frame according to the second embodiment.

FIG. 27 shows a STA specific tone group index according to a third embodiment of the present disclosure.

FIG. 28 shows an example format of a Common Info field of an EHT MB NFRP Trigger frame according to the third embodiment.

FIG. 29 shows an example format of a User Info field of an EHT MB NFRP Trigger frame according to the third embodiment.

FIG. 30 shows an example format of a BSS Specific Tone Group Indication subfield of a User Info field in an EHT MB NFRP Trigger frame according to the third embodiment.

FIG. 31 shows another example format of a Common Info field of an EHT MB NFRP Trigger frame according to the third embodiment.

FIG. 32 shows another example format of a User Info field of an EHT MB NFRP Trigger frame according to the third embodiment.

FIG. 33 shows a STA specific tone group index according to a fourth embodiment of the present disclosure.

FIG. 34 shows an example format of a Common Info field of an EHT MB NFRP Trigger frame according to the fourth embodiment.

FIG. 35 shows an example format of a User Info field of an EHT MB NFRP Trigger frame according to the fourth embodiment.

FIG. 36 shows an example format of a BSS Specific Tone Group Indication subfield of a User Info field in an EHT MB NFRP Trigger frame according to the fourth embodiment.

FIG. 37 shows another example format of a Common Info field of an EHT MB NFRP Trigger frame according to the fourth embodiment.

FIG. 38 shows another example format of a User Info field of an EHT MB NFRP Trigger frame according to the fourth embodiment.

FIG. 39 shows a flow chart illustrating a procedure carried out by a STA when receiving an EHT MB NFRP Trigger frame according to an embodiment.

FIG. 40 shows an example format of a User Info field of an EHT MB NFRP Trigger frame according to yet another embodiment of the present disclosure.

FIG. 41 shows a flow diagram illustrating communications of a multi-AP based NDP feedback report procedure according to yet another embodiment of the present disclosure.

FIG. 42 shows a configuration of a communication device, for example an AP, according to the present disclosure.

FIG. 43 shows a configuration of a communication device, for example an STA, according to the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help an accurate understanding of the present embodiments.

### DETAILED DESCRIPTION

Some embodiments of the present disclosure will be described, by way of example only, with reference to the drawings. Like reference numerals and characters in the drawings refer to like elements or equivalents.

In the following paragraphs, certain exemplifying embodiments are explained with reference to one or more access point (AP) and one or more station (STA) for NDP (null data packet) feedback report, especially in a multiple-input multiple-output (MIMO) wireless network.

In the context of IEEE 802.11 (Wi-Fi) technologies, a station, which is interchangeably referred to as a STA, is a communication apparatus that has the capability to use the 802.11 protocol. Based on the IEEE 802.11-2016 definition, a STA can be any device that contains an IEEE 802.11-conformant media access control (MAC) and physical layer (PHY) interface to the wireless medium (WM).

For example, a STA may be a laptop, a desktop personal computer (PC), a personal digital assistant (PDA), an access point or a Wi-Fi phone in a wireless local area network (WLAN) environment. The STA may be fixed or mobile. In the WLAN environment, the terms “STA”, “wireless client”, “user”, “user device”, and “node” are often used interchangeably.

Likewise, an AP, which may be interchangeably referred to as a wireless access point (WAP) in the context of IEEE 802.11 (Wi-Fi) technologies, is a communication apparatus that allows STAs in a WLAN to connect to a wired network. The AP usually connects to a router (via a wired network) as a standalone device, but it can also be integrated with or employed in the router.

As mentioned above, a STA in a WLAN may work as an AP at a different occasion, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

In a MIMO wireless network, “multiple” refers to multiple antennas used simultaneously for transmission and multiple antennas used simultaneously for reception, over a radio channel. In this regard, “multiple-input” refers to multiple transmitter antennas, which input a radio signal into the channel, and “multiple-output” refers to multiple receiver antennas, which receive the radio signal from the channel and into the receiver. For example, in an N×M MIMO network system, N is the number of transmitter antennas, M is the number of receiver antennas, and N may or may not be equal to M. For the sake of simplicity, the respective numbers of transmitter antennas and receiver antennas are not discussed further in the present disclosure.

In a MIMO wireless network, single-user (SU) communications and multi-user (MU) communications can be deployed for communications between communication apparatuses such as APs and STAs. MIMO wireless network has benefits like spatial multiplexing and spatial diversity, which enable higher data rates and robustness through the use of multiple spatial streams. According to various embodiments, the term “spatial stream” may be used interchangeably with the term “space-time stream” (or STS).

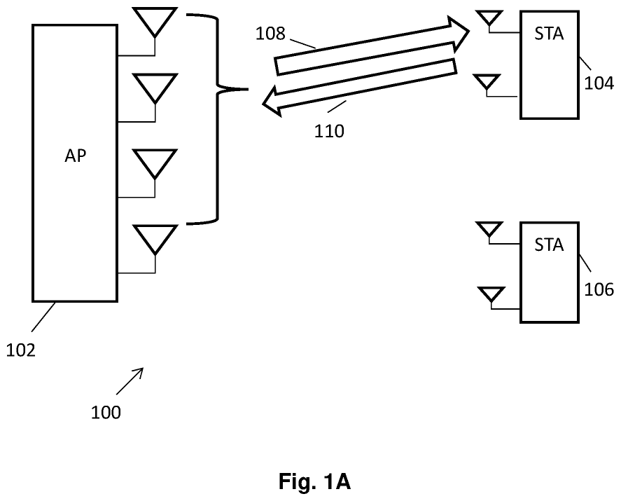

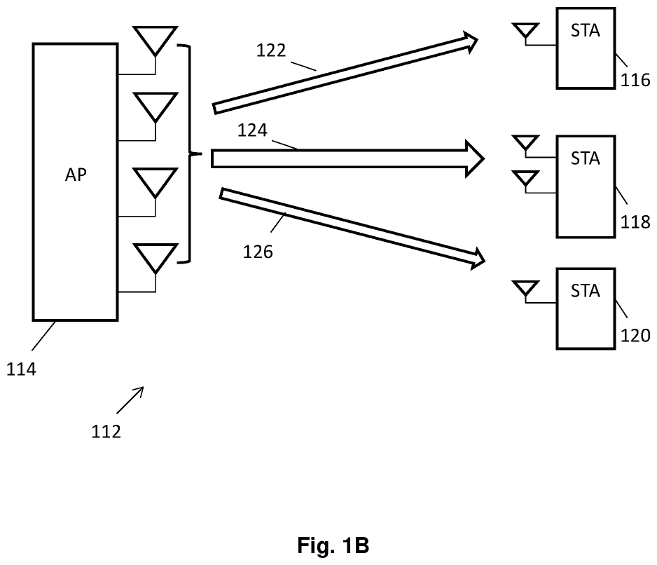

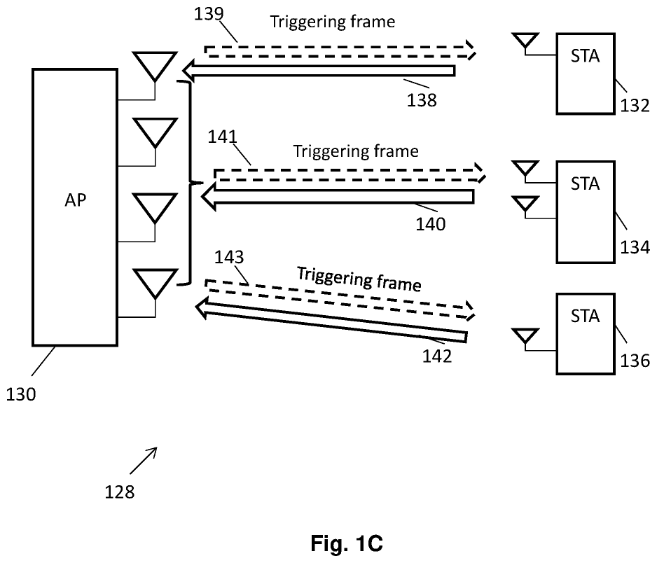

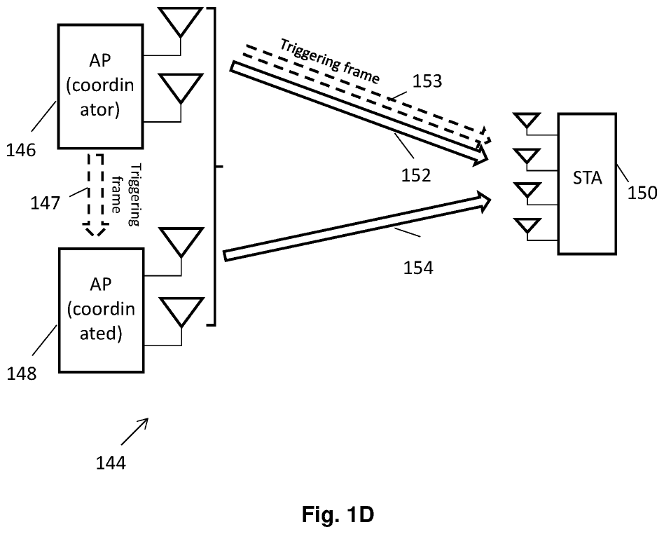

FIG. 1A depicts a schematic diagram of SU communication 100 between an AP 102 and a STA 104 in a MIMO wireless network. As shown, the MIMO wireless network may include one or more STAs (e.g. STA 104, STA 106, etc.). If the SU communication 100 in a channel is carried out over whole channel bandwidth, it is called full bandwidth SU communication. If the SU communication 100 in a channel is carried out over a part of the channel bandwidth (e.g. one or more 20 MHz subchannels within the channel is punctured), it is called punctured SU communication. In the SU communication 100, the AP 102 transmits multiple space-time streams using multiple antennas (e.g. four antennas as shown in FIG. 1A) with all the space-time streams directed to a single communication apparatus, i.e. the STA 104. For the sake of simplicity, the multiple space-time streams directed to the STA 104 are illustrated as a grouped data transmission arrow 108 directed to the STA 104.

The SU communication 100 can be configured for bi-directional transmissions. As shown in FIG. 1A, in the SU communication 100, the STA 104 may transmit multiple space-time streams using multiple antennas (e.g. two antennas as shown in FIG. 1A) with all the space-time streams directed to the AP 102. For the sake of simplicity, the multiple space-time streams directed to the AP 102 are illustrated as a grouped data transmission arrow 110 directed to the AP 102.

As such, the SU communication 100 depicted in FIG. 1A enables both uplink and downlink SU transmissions in a MIMO wireless network.

FIG. 1B depicts a schematic diagram of downlink MU communication 112 between an AP 114 and multiple STAs 116, 118, 120 in a MIMO wireless network. The MIMO wireless network may include one or more STAs (e.g. STA 116, STA 118, STA 120, etc.). The MU communication 112 can be an OFDMA (orthogonal frequency division multiple access) communications or a MU-MIMO communication. For an OFDMA communication in a channel, the AP 114 transmits multiple streams simultaneously to the STAs 116, 118, 120 in the network at different resource units (RUs) within the channel bandwidth. For a MU-MIMO communication in a channel, the AP 114 transmits multiple streams simultaneously to the STAs 116, 118, 120 at same RU(s) within the channel bandwidth using multiple antennas via spatial mapping or precoding techniques. If the RU(s) at which the OFDMA or MU-MIMO communication occurs occupy whole channel bandwidth, the OFDMA or MU-MIMO communications is called full bandwidth OFDMA or MU-MIMO communications. If the RU(s) at which the OFDMA or MU-MIMO communication occurs occupy a part of channel bandwidth (e.g. one or more 20 MHz subchannel within the channel is punctured), the OFDMA or MU-MIMO communication is called punctured OFDMA or MU-MIMO communications. For example, two space-time streams may be directed to the STA 118, another space-time stream may be directed to the STA 116, and yet another space-time stream may be directed to the STA 120. For the sake of simplicity, the two space-time streams directed to the STA 118 are illustrated as a grouped data transmission arrow 124, the space-time stream directed to the STA 116 is illustrated as a data transmission arrow 122, and the space-time stream directed to the STA 120 is illustrated as a data transmission arrow 126.

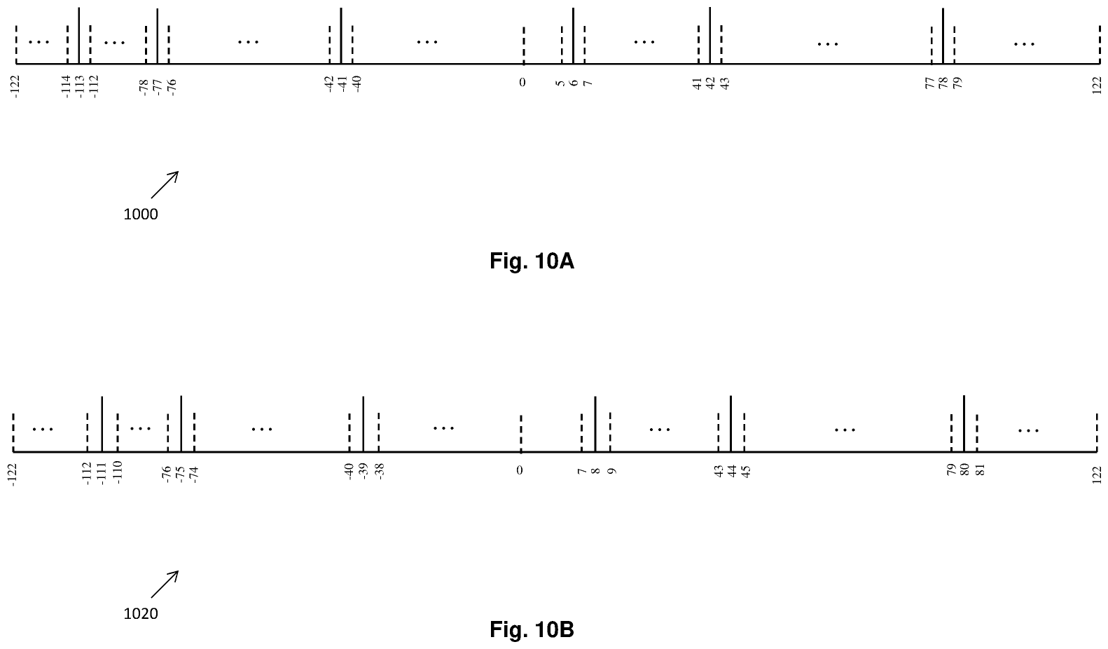

To enable uplink MU transmissions, trigger-based communication is provided to the MIMO wireless network. In this regard, FIG. 10 depicts a schematic diagram of trigger-based uplink MU communication 128 between an AP 130 and multiple STAs 132, 134, 136 in a MIMO wireless network.

Since there are multiple STAs 132, 134, 136 participating in the trigger-based uplink MU communication, the AP 130 needs to coordinate simultaneous transmissions of multiple STAs 132, 134, 136.

To do so, as shown in FIG. 10, the AP 130 transmits triggering frames 139, 141, 143 simultaneously to STAs 132, 134, 136 to indicate user-specific resource allocation information (e.g. the number of space-time streams, a starting STS number and the allocated RUs) each STA can use. In response to the triggering frames, STAs 132, 134, 136 may then transmit their respective space-time streams simultaneously to the AP 130 according to the user-specific resource allocation information indicated in the triggering frames 139, 141, 143. For example, two space-time streams may be directed to the AP 130 from STA 134, another space-time stream may be directed to the AP 130 from STA 132, and yet another space-time stream may be directed to the AP 130 from STA 136. For the sake of simplicity, the two space-time streams directed to the AP 130 from STA 134 are illustrated as a grouped data transmission arrow 140, the space-time stream directed to the AP 130 from STA 132 is illustrated as a data transmission arrow 138, and the space-time stream directed to the AP 130 from STA 136 is illustrated as a data transmission arrow 142.

Trigger-based communication is also provided to the MIMO wireless network to enable downlink multi-AP communication. In this regard, FIG. 1D depicts a schematic diagram of downlink multi-AP communication 144, between a STA 150 and multiple APs 146, 148 in a MIMO wireless network.

Since there are multiple APs 146, 148 participating in the trigger-based downlink multi-AP MIMO communication, the coordinator AP 146 needs to coordinate simultaneous transmissions of multiple APs 146, 148.

To do so, as shown in FIG. 1D, the coordinator AP 146 transmits triggering frames 147, 153 simultaneously to the AP 148 and the STA 150 to indicate AP-specific resource allocation information (e.g. the number of space-time streams, a starting STS stream number and the allocated RUs) each AP can use. In response to the triggering frames, the multiple APs 146, 148 may then transmit respective space-time streams to the STA 150 according to the AP-specific resource allocation information indicated in the triggering frame 147; and the STA 150 may then receive all the space-time streams according to the AP-specific resource allocation information indicated in the triggering frame 153. For example, two space-time streams may be directed to the STA 150 from AP 146, and another two space-time streams may be directed to the STA 150 from AP 148. For the sake of simplicity, the two space-time streams directed to the STA 150 from AP 146 are illustrated as a grouped data transmission arrow 152, and the two space-time streams directed to the STA 150 from the AP 148 is illustrated as a grouped data transmission arrow 154.

Due to packet/PPDU (physical layer protocol data unit) based transmission and distributed MAC (medium access control) scheme in 802.11 WLAN, time scheduling (e.g. TDMA (time division multiple access)-like periodic time slot assignment for data transmission) does not exist in 802.11 WLAN. Frequency and spatial resource scheduling is performed on a packet basis. In other words, resource allocation information is on a PPDU basis.

According to various embodiments, EHT WLAN supports non-trigger-based communications as illustrated in FIG. 1A and FIG. 1B and trigger-based communications as illustrated in FIG. 10 and FIG. 1D. In non-trigger-based communications, a communication apparatus transmits a PPDU to one other communication apparatus or more than one other communication apparatuses in an unsolicited manner. In trigger-based communications, a communication apparatus transmits a PPDU to one other communication apparatus or more than one other communication apparatuses only after a soliciting triggering frame is received.

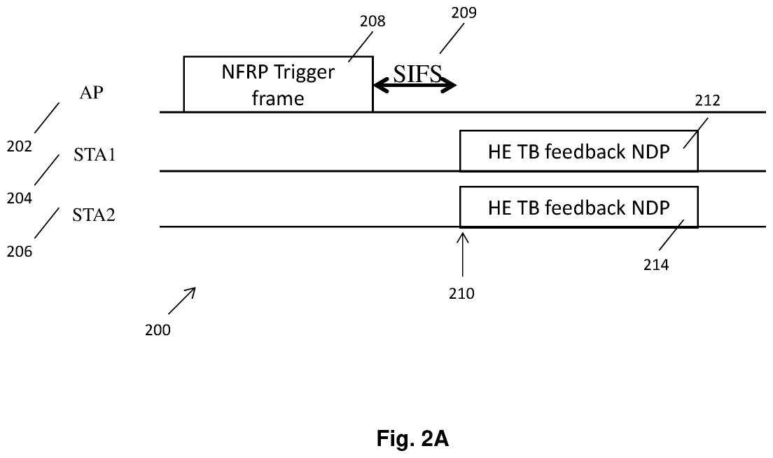

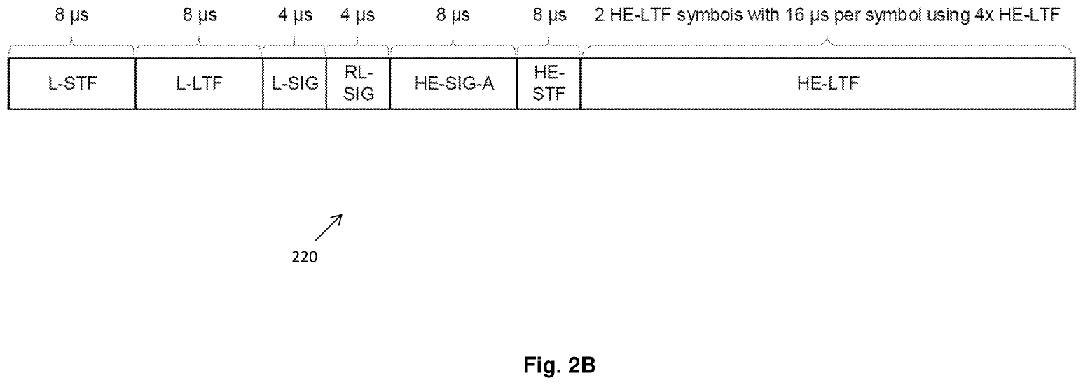

FIG. 2A shows a flow diagram 200 illustrating communications of an 802.11ax single-AP (access point) based null data packet (NDP) feedback report procedure. A 802.11ax device supports single-AP based NDP feedback report procedure, where an AP like 202 and/or STA(s) like 204, 206 engaged in a single-AP based NDP feedback report procedure belong to a single basic service set (BSS). In this embodiment, a high efficiency (HE) AP transmits a NDP Feedback Report Poll (NFRP) Trigger frame 208 to two STAs (STA1 204 and STA2 206) to solicit simultaneous NDP feedback report response from the two STAs 204, 206.

In IEEE 802.11 networks, a SIFS is the time spacing prior to transmission of an acknowledgement by a STA. After the last symbol of the Trigger frame 208 is transmitted, a SIFS 209 may take effect and at 210, the STA1 204 and the STA2 206 may transmit respective HE Trigger-based (TB) Feedback NDPs 212, 214 to the HE AP 202. The HE TB Feedback NDPs 212, 214 are the feedback report response from the STAs 204, 206.

FIG. 2B shows an example format of a HE TB Feedback NDP 220. The HE TB

Feedback NDP may comprise a non-High Throughput Short Training field (L-STF), a non-High Throughput Long Training field (L-LTF), a non-High Throughput SIGNAL (L-SIG) field, a Repeated L-SIG (RL-SIG) field, a HE SIGNAL A (HE-SIG-A) field, a HE Short Training Field (HE-STF), a HE Long Training Field (HE-LTF). The guard intervals (GIs) of the L-STF, L-LTF, L-SIG field, RL-SIG field, HE-SIG-A field,

HE-STF are 8 μs, 8 μs, 4 μs, 4 μs, 8 μs and 8 μs respectively, while the HE-LTF comprises 2 HE-LTF symbols with 16 μs per symbol using 4× HE-LTF. It is noted that different STA specific tone groups are used by HE-LTF fields in the HE TB Feedback NDPs like 212, 214 transmitted from different STAs like 204, 206, respectively.

It is noted that in 11be EHT WLAN, APs and STAs engaged in a multi-AP operation may belong to different BSSs, and the 11ax-like single-AP based NDP feedback report procedure as illustrated in FIG. 2A is unable to support such operation. Therefore, in order to improve throughput in 11be EHT WLAN over 11ax HE WLAN, it is an object to of present disclosure to substantially overcome the existing challenges to provide communication apparatuses and methods for multi-AP based NDP feedback report procedure.

According to various embodiments of the present disclosure, multi-AP based NDP feedback report procedure is carried out in the following steps. Firstly, a coordinator AP sends a Multi-AP (MAP) Announcement frame to initiate multi-AP based NDP feedback report procedure. An intended type of multi-AP based NDP feedback report procedure is indicated in the MAP Announcement frame such as a sequential procedure or a joint procedure. In an embodiment, the coordinator AP may decide to use sequential or joint procedure based on real situation, for example whether coordinated AP(s) supports joint procedure and/or the number of STAs associated with each AP in the multi-AP configuration. It is noted that multi-AP based NDP feedback report could be used to report buffer status for uplink (UL) MU transmission.

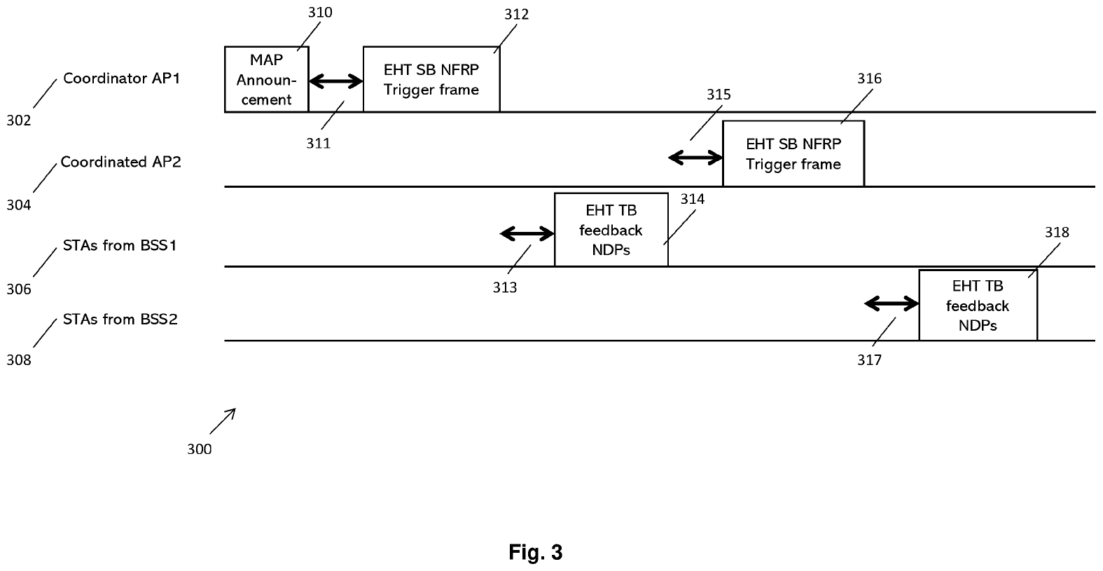

If sequential procedure is indicated in the MAP Announcement frame, subsequent to the transmission of the MAP Announcement frame, after a SIFS, APs sequentially send EHT Single-AP based EHT Single-AP Based (SB) NFRP Trigger frame to solicit EHT TB Feedback NDPs from respective associated STAs (within the same BSS). After a SIFS following each EHT SB NFRP Trigger frame transmitted by an AP, a STA(s) that satisfies condition then transmits an EHT TB Feedback NDP in response to the received EHT SB NFRP Trigger frame to the associated AP. Such sequential multi-AP based NDP feedback report procedure is illustrated in FIG. 3.

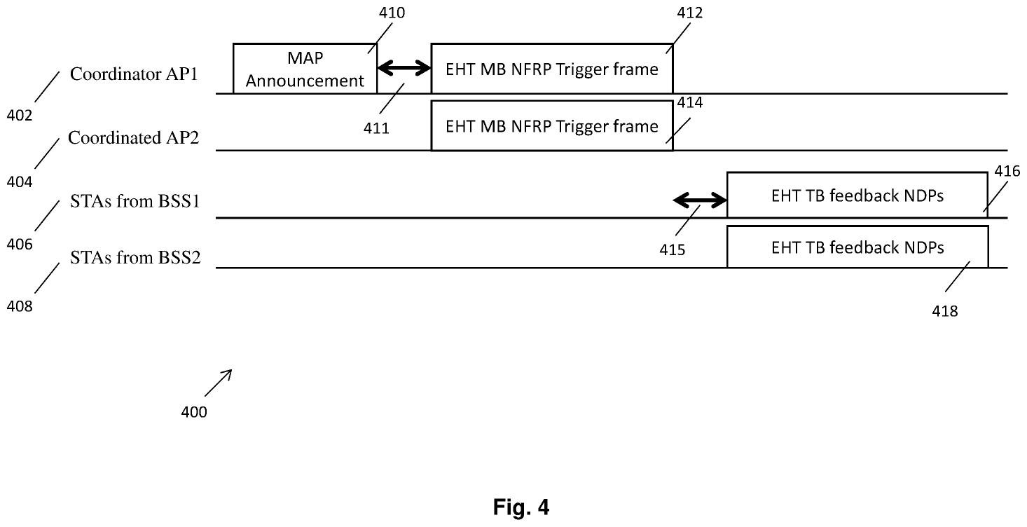

If joint procedure is indicated in the MAP Announcement frame, subsequent to the transmission of the MAP Announcement frame, after a SIFS, AP(s) simultaneously sends EHT Multi-AP based (MB) NFRP Trigger frame(s) to solicit simultaneous EHT TB Feedback NDPs from STAs from different BSSs. After a SIFS following the EHT MB NFRP Trigger frame(s), STAs that satisfy conditions simultaneously send respective EHT TB Feedback NDPs to the associated APs. Such joint multi-AP based NDP feedback report procedure is illustrated in FIG. 4.

FIG. 3 shows a flow diagram 300 illustrating communications of a sequential multi-AP based NDP feedback report procedure according to an embodiment. In this embodiment, a first AP (coordinator AP1) 302 may belong to BSS1 and is associated with STAs from BSS1 306 while a second AP (coordinated AP2) 304 may belong to BSS2 and is associated with STAs from BSS2 308. The coordinator AP1 302 transmits a MAP Announcement frame 310 where a sequential procedure is indicated as the intended type of multi-AP based NDP feedback report procedure in the frame 310. The MAP Announcement frame 310 shall indicate coordinated AP ordering, and thus the transmit timing of the EHT SB NFRP Trigger frame of each AP could be simply calculated by each AP itself. Under sequential procedure, each AP sends EHT SB NFRP Trigger frame to its associated STAs following the ordering.

After the last symbol of the MAP Announcement frame 310 is transmitted, a SIFS 311 may take effect, and, the coordinator AP1 302 transmits an EHT SB NFRP Trigger frame 312 to solicit an EHT TB Feedback NDP from each of the associated STAs from BSS1 306. Subsequently, a SIFS 313 may take effect, and the STAs from BSS1 306 transmit respective EHT TB Feedback NDPs 314 to the coordinator AP1 302.

After the last symbol of the EHT TB Feedback NDPs 314 are transmitted, a SIFS 315 may take effect, and the coordinated AP2 304 transmits an EHT SB NFRP Trigger frame 316 to solicit an EHT TB Feedback NDP from each of the associated STAs from BSS2 308. Subsequently, a SIFS 317 may take effect, and the STAs from BSS2 308 transmit respective EHT TB Feedback NDPs 318 to the coordinated AP2 304.

A sequential procedure is a better choice than a joint procedure under a scenario where large number of STAs are engaged in the multi-AP based NDP feedback report procedure as AP(s) can schedule more STAs to feedback in a sequential manner than in a joint manner.

FIG. 4 shows a flow diagram 400 illustrating communications of a joint multi-AP based NDP feedback report procedure according to another embodiment. In this embodiment, a first AP (coordinator AP1) 402 may belong to BSS1 and is associated with STAs from BSS1 406 while a second AP (coordinated AP2) 404 may belong to BSS2 and is associated with STAs from BSS2 408. Prior to multi-AP feedback report procedure, identification information of intended STAs from different BSSs may have been exchanged between APs. It is noted that the first association identifier (AID) of the range of AIDs, together with an identifier of BSS with which STAs are associated, is used to identify intended STAs in a multi-AP system.

The coordinator AP1 402 transmits a MAP Announcement frame 410 where a joint procedure is indicated as the intended type of multi-AP based NDP feedback report procedure in the frame 410. The MAP Announcement frame shall indicate coordinated AP(s) and the intended type of BSS specific tone group formation.

After the last symbol of the MAP Announcement frame 410 is transmitted, a SIFS 411 may take effect, and the coordinator AP1 402 and the coordinated AP2, which engaged in the multi-AP system, simultaneously transmit same EHT MB NFRP Trigger frames 412, 414 to respective associated STAs, in this case STAs from BSS1 and BSS2 406, 408 respectively, to solicit simultaneous EHT TB Feedback NDPs from the STAs from BSS1 and BSS2 406, 408. The EHT MB NFRP Trigger frames 412, 414 shall indicate information of BSS specific tone group used by the EHT-LTF field in EHT TB Feedback NDP, such that different BSS specific tone groups are used by EHT-LTF field in EHT TB Feedback NDP transmitted by STAs from different BSSs.

After the last symbol of the EHT MB NFRP Trigger frame 412, 414 are transmitted, a SIFS 315 may take effect, and the STAs from BSS1 406 and the STAs from BSS2 408 simultaneously transmit EHT TB Feedback NDPs 416, 418 to the coordinator AP1 402 and the coordinated AP2 404, respectively. The EHT-LTF fields of EHT TB Feedback NDPs 416, 418 sent from the STAs from BSS1 and BSS2 406, 408 may be transmitted under BSS specific tone groups corresponding to those indicated in the EHT MB NFRP Trigger frames 412, 414 transmitted by the coordinator AP1 402 and the coordinated AP2, respectively.

Advantageously, a joint procedure enables STAs from different BSSs to respond to EHT MB NFRP Trigger frame at the same time and avoid interference between cell-edge STAs by using different tones.

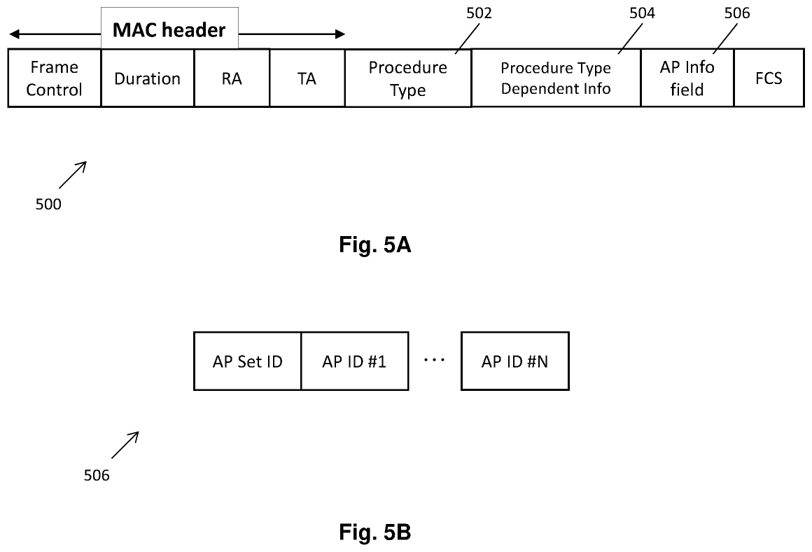

FIG. 5A shows an example format of a MAP Announcement frame 500. The MAP Announcement frame comprises a Frame Control field, a Duration field, a Receiver Address (RA) field, a Transmitter Address (TA) field, a Procedure Type field 502, a Procedure Type Dependent Info field 504, an AP Info field 506 and a FCS (frame check sequence) field. The Frame Control field, the Duration field, the RA field and the TA field may be grouped as MAC header. The Procedure Type field 502 may indicate an intended type, for example whether a sequential procedure or a joint procedure, is used as a multi-AP based NDP feedback report procedure. When the Procedure Type subfield 502 refers to as “Sequential procedure”, the transmission ordering could be indicated by the ordering of AP ID subfields in the AP Info field 506 and the Procedure Type Dependent Info field 504 is reserved. When the Procedure Type subfield 502 refers to as “Joint procedure”, the Procedure Type Dependent Info field 504 comprises an Intended BSS Specific Tone Group Formation Type field to indicate an intended type of BSS specific tone group formation.

FIG. 5B shows an AP Info field 504 of the MAP Announcement frame 500 according to an embodiment. The AP Info field 506 comprises an AP Set ID subfield indicating information of AP set ID relating to a coordinated AP set and one or more AP ID subfields, each of which indicates information identifying an intended AP in the coordinated AP set. In an embodiment, the AP Set ID subfield indicates a coordinated AP set. The intended AP in a coordinated AP set could be identified by AP set ID and AP ID. In an embodiment, the AP set ID and AP ID may be broadcasted to STAs before multi-AP based NDP feedback report procedure, for example through Beacon frame or Probe Response frame.

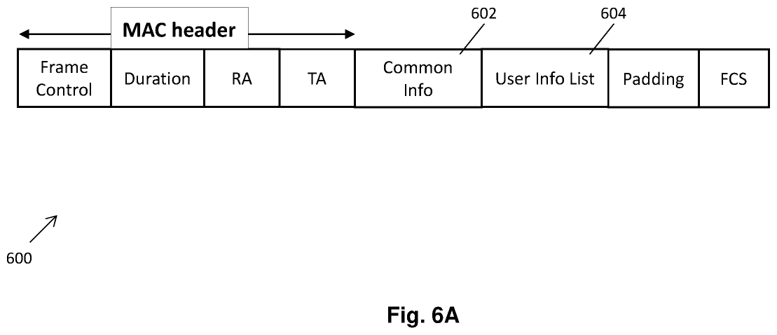

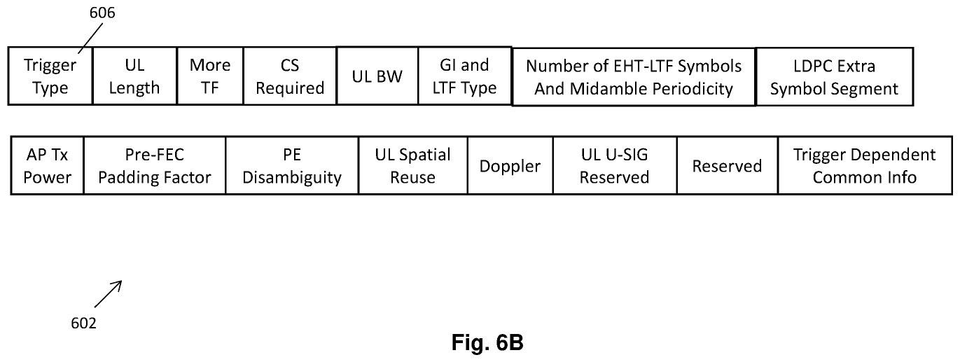

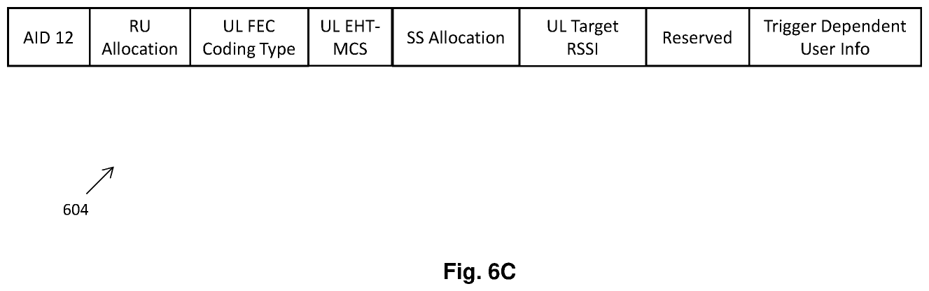

FIG. 6A shows an example format of an extremely high throughput (EHT) Trigger frame 600. The EHT Trigger frame 600 comprises a Frame Control field, a Duration field, a RA field, a TA field, a Common Info field 602, a User Info List field 604, a Padding field and a FCS field. The Frame Control field, the Duration field, the RA field and the TA field may be grouped as MAC header.

FIG. 6B shows an example format of a Common Info field 602 of an EHT Trigger frame 600. The Common field 602 comprises a Trigger Type subfield 606, a UL Length subfield, a More TF subfield, a CS Required subfield, a UL Bandwidth (BW) subfield, a GI and LTF Type subfield, a Number of EHT-LTF Symbols And Midamble Periodicity subfield, a Low Density Parity Check (LDPC) Extra Symbol Segment subfield, an AP Transmission (Tx) Power subfield, a PE Disambiguity subfield, a UL Spatial Resue subfield, a Doppler subfield a UL U-SIG Reserved subfield and a Trigger Dependent Common Info field. The Trigger Type subfield 606 identifies the EHT Trigger frame variant. Examples of an EHT Trigger frame variant corresponding to a Trigger Type subfield 606 value is shown in Table 1. The UL BW subfield indicates the BW of the EHT TB Feedback NDP and may indicate BW ranged from 20 MHz to 320 MHz.

TABLE 1
Examples of an EHT Trigger frame variant corresponding
to a Trigger Type subfield value.

| Trigger Type subfield value | EHT Trigger frame variant |
|---|---|
| 0 | EHT Basic |
| 1 | EHT Single-AP Based NDP Feedback |
| | Report Poll (EHT SB NFRP) |
| 2 | EHT Multi-AP Based NDP Feedback |
| | Report Poll (EHT MB NFRP) |
| 3~15 | Reserved |

FIG. 6C shows an example format of a User Info field 604 of an EHT Trigger frame 600. The User Info field 604 comprises a AID 12 subfield, a RU allocation subfield, a UL Forward Error Correction (FEC) Coding Type subfield, a UL EHT-MCS (Modulation and Coding Scheme) subfield, a Spatial Stream (SS) Allocation subfield, a UL Target Received Signal Strength Indicator (RSSI) subfield and a Trigger Dependent User Info subfield.

When the Trigger Type subfield 606 refers to as “EHT Single-AP Based NDP Feedback Report Poll (EHT SB NFRP)” or “EHT Multi-AP Based NDP Feedback Report Poll (EHT MB NFRP)”. The LDPC Extra Symbol Segment subfield, Pre-FEC Padding Factor subfield, PE Disambiguity subfield, UL Spatial Reuse subfield, and Doppler subfields in the Common Info field are reserved.

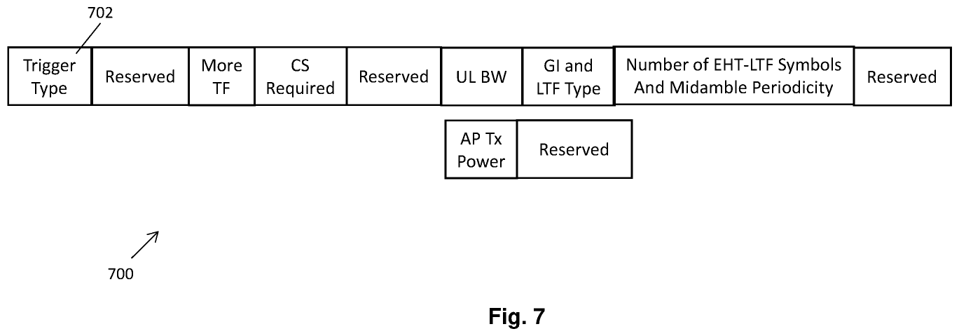

FIG. 7 shows an example format of a Common Info field 700 of an EHT SB NFRP Trigger frame. In this example, the Common Info field 700 comprises a Trigger Type subfield 702 referring to as “EHT SB NFRP”. In an embodiment, a Trigger Dependent Common Info field is not present in an EHT SB NFRP Trigger frame, as shown in FIG. 7. An EHT SB NFRP Trigger frame can be used both in single-AP based NDP feedback report procedure or multi-AP based sequential NDP feedback report procedure.

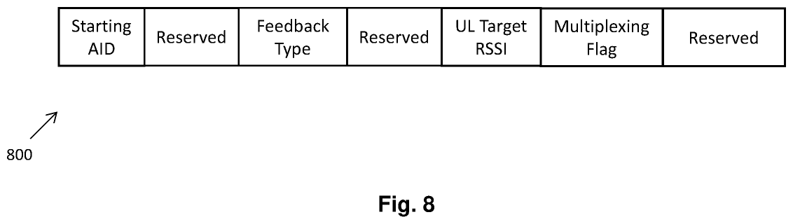

FIG. 8 shows an example of a User Info field 800 of an EHT SB NFRP Trigger frame. In various embodiments, a User Info List field of an EHT SB NFRP Trigger frame comprises one User Info field 800. Unlike the User Info field 604 of the EHT Trigger frame 600 in FIG. 6C, a Trigger Dependent User Info subfield is not present in the User Info field 800 of the EHT SB NFRP Trigger frame.

Example formats of a Common Info field and a User Info field of an EHT MB NFRP Trigger frame, where the Trigger Type subfield refers to as “EHT MB NFRP” will be further elaborated in various embodiments of the present disclosure later.

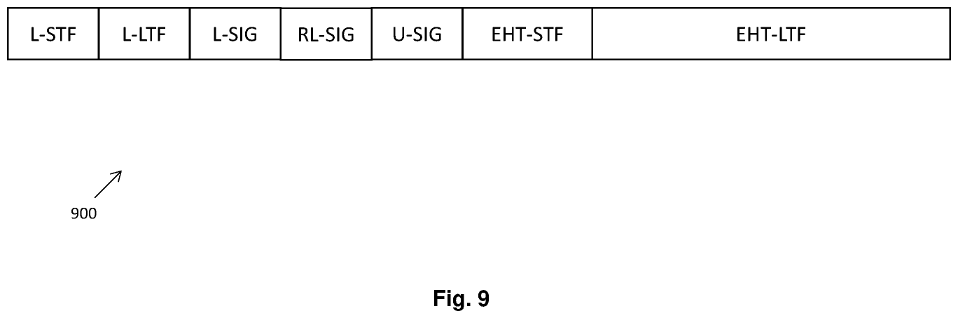

FIG. 9 shows an example format of an EHT TB Feedback NDP 900. The EHT TB Feedback NDP comprises a L-STF, a L-LTF, a L-SIG field, a RL-SIG field, a U-SIG field, an EHT-STF and an EHT-LTF. The EHT-LTF carries feedback information. Different STAs may be mapped into different tones and use the tones in their EHT-LTF fields to carry feedback information. The terminologies “subcarrier” and “tone” are used interchangeably thereafter; and the terminologies “frequency segment” and “subchannel” are used interchangeably thereafter.

FIGS. 10A and 10B show example frequency domain representations 1000, 1020 of EHT-LTF symbols of an EHT-LTF field in respective 20 MHz EHT TB Feedback NDPs transmitted by two STAs (STA1 and STA2), assuming STA1 and STA2 are scheduled to respond with the EHT TB Feedback NDPs. In FIG. 10. It is shown that all tones are 0 except tones −113, −77, −41, 6, 42 and 78. This indicates that six tones or frequency domains (113, −77, −41, 6, 42 and 78) are assigned to STA1 and used to carry STA1's feedback information in an EHT TB Feedback NDP transmitted by STA1. On the other hand, in FIG. 10B, it is shown that all tones are 0 except tones 15 −111, −75, −39, 8, 44 and 80. This indicates six tones or frequency domain (−11, −86, −39, −8, −44, −80), which are different from those of STA1, are assigned to STA2 and used to carry STA2's feedback information in an EHT TB Feedback NDP transmitted by STA2.

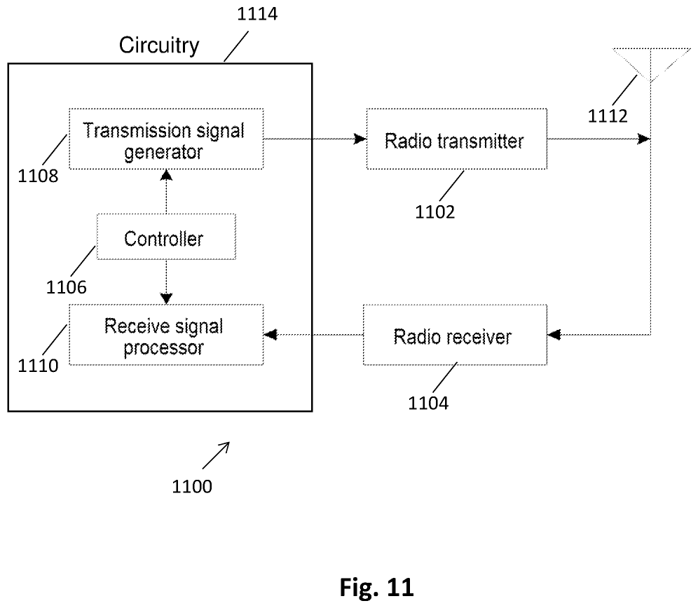

FIG. 11 shows a schematic example of communication apparatus in accordance with various embodiments. The communication apparatus may be implemented as an AP or a STA and configured for NDP feedback report in accordance with the present disclosure. As shown in FIG. 11, the communication apparatus 1100 may include circuitry 1114, at least one radio transmitter 1102, at least one radio receiver 1104, and at least one antenna 1112 (for the sake of simplicity, only one antenna is depicted in FIG. 11 for illustration purposes). The circuitry 1114 may include at least one controller 1106 for use in software and hardware aided execution of tasks that the at least one controller 1106 is designed to perform, including control of communications with one or more other communication apparatuses in a MIMO wireless network. The circuitry 1114 may furthermore include at least one transmission signal generator 1108 and at least one receive signal processor 1110. The at least one controller 1106 may control the at least one transmission signal generator 1108 for generating MAC frames (for example MAP Announcement frames and EHT Trigger frames) and PPDUs (for example EHT MU PPDUs if the communication apparatus 1100 is an AP, and for example EHT MU PPDUs or EHT TB Feedback NDPs if the communication apparatus 1100 is a STA) to be sent through the at least one radio transmitter 1102 to one or more other communication apparatuses and the at least one receive signal processor 1110 for processing MAC frames (for example MAP Announcement frames or EHT Trigger frames) and PPDUs (for example EHT MU PPDUs or EHT TB Feedback NDPs if the communication apparatus 1100 is an AP, and for example EHT MU PPDUs if the communication apparatus 1100 is a STA) received through the at least one radio receiver 1104 from the one or more other communication apparatuses under the control of the at least one controller 1106. The at least one transmission signal generator 1108 and the at least one receive signal processor 1110 may be stand-alone modules of the communication apparatus 1100 that communicate with the at least one controller 1106 for the above-mentioned functions, as shown in FIG. 11. Alternatively, the at least one transmission signal generator 1108 and the at least one receive signal processor 1110 may be included in the at least one controller 1106. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 1102, at least one radio receiver 1104, and at least one antenna 1112 may be controlled by the at least one controller 1106.

The communication apparatus 1100, when in operation, provides functions required for multi-AP based NDP feedback report. For example, the communication apparatus 1100 may be an AP (for example a coordinator AP), and the circuitry 1114 (for example the at least one transmission signal generator 1108 of the circuitry 1114) may, in operation, generate a first frame (for example MAP Announcement frame) comprising a first field (for example Procedure Type field) indicating an intended type of NDP feedback report procedure to initiate a NDP feedback report procedure. The radio transmitter 1102 may in operation, transmit the first frame to one or more peer communication apparatuses (for example coordinated APs).

In various embodiments, the first field of the first frame indicates that a second frame of the communication apparatus 1100 and respective frames of the one or more peer communication apparatuses are to be simultaneously transmitted. The first frame comprises a second field (for example Intended BSS Specific Tone Group Formation Type field) indicating an intended manner to assign a plurality of tones to each of one or more BSSs.

In various embodiments, the circuitry 1114 (for example the at least one transmission signal generator 1108 of the circuitry 1114) may, in operation, generate a second frame (for example EHT Trigger frame) to solicit a NDP feedback report. In an embodiment, the second frame comprises a first field indicating an alignment of the NDP feedback report transmitted by different STAs. In another embodiment, the second frame comprises a second field indicating an index of tones (for example a BSS specific tone group) assigned to each of one or more BSSs.

The communication apparatus 1100 may be a peer AP (for example a coordinated AP), and the radio receiver 1104 may, in operation, receive a first frame (for example MAP Announcement frame) from one other communication apparatus (e.g. a coordinator AP), the first frame comprising a first field (for example Procedure Type field) indicating an intended type of NDP feedback report procedure to initiate a NDP feedback report procedure. The circuitry 1114 (for example the at least one receive signal processor 1110 of the circuitry 1114) may, in operation, process the first frame.

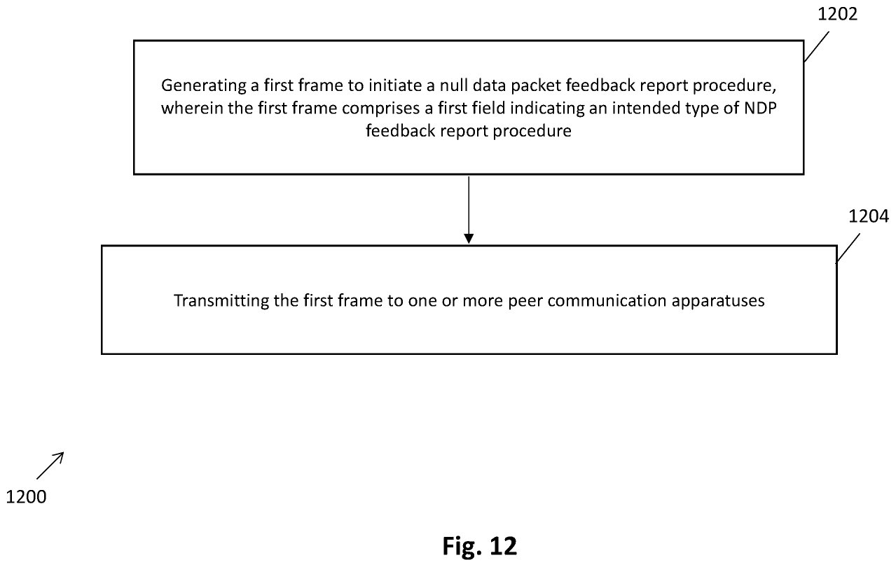

FIG. 12 shows a flow diagram illustrating a communication method according to the present disclosure. In step 1202, a first frame is generated to initiate a NDP feedback procedure, the first frame comprising a first field indicating an intended type of NDP feedback report procedure. In step 1204, the first frame is then transmitted to one or more peer communication apparatuses.

According to the present disclosure, BSS specific tone group information are indicated in the EHT MB NFRP Trigger frame. BSS specific tone group formation is carried out in two steps. The first step relates to STA specific tone group formation where each 12 tones are comprised in a STA specific tone group assigned to a STA. There are two options for STA specific tone group formation (Option 1 and Option 2). Under Option 1, tones corresponding to a STA specific tone group belong to a same 20 MHz frequency segment, which is consistent with 802.11ax. Table 2 shows an example STA specific tone group formation in 20 MHz EHT TB Feedback NDP (Option 1). In this example, 18 STA specific tone groups, each of which comprises 12 different tones, are formed. Further, each of the 12 tones of a STA specific tone group comprises two subgroups of six tones which indicate different feedback information, in this case feedback status of 1 or 0 respectively. For example, STA specific tone group 1 (index=1) comprises 12 STA specific tones (−113, −112, −77, −76, −41, −40, 6, 7, 42, 43, 78, 79), six of the STA specific tones (−113, −77, −41, 6, 42, 78) are used to indicate a feedback status of 1 and the remaining six (−112, −76, −40, 7, 43, 79) are used to indicate a feedback status of 0. Under Option 2, tones corresponding to a STA specific tone group may not belong to a same 20 MHz frequency segment.

TABLE 2
An example STA specific tone group formation in a
20 MHz EHT TB Feedback NDP.

| STA specific | STA specific | STA specific tones when |
|---|---|---|
| tone group | tones when | |
| Index | feedback status = 1 | feedback status = 0 |
| 1 | −113, −77, −41, 6, 42, 78 | −112, −76, −40, 7, 43, 79 |
| 2 | −111, −75, −39, 8, 44, 80 | −110, −74, −38, 9, 45, 81 |
| . . . | . . . | . . . |
| 18 | −79, −43, −7, 40, 76, 112 | −78, −42, −6, 41, 77, 113 |

The second step of BSS specific tone group formation relates to assigning different STA specific tone groups to different BSSs, where a collection of STA specific tone groups that are assigned to a BSS corresponds to a BSS specific tone group. In an example where a first BSS (BSS#1) and a second BSS (BSS#2) are engaged in a multi-AP operation in 20 MHz, STA specific tone groups from index 1 to index 9 (e.g. as shown in Table 2) may be assigned to BSS#1, whereas STA specific tone groups from index 10 to index 18 may be assigned to BSS#2.

The more STA specific tone groups are comprised in a BSS specific tone group, the more STAs can be supported in the multi-AP based NDP feedback report procedure in the BSS.

According to the present disclosure, the intended type of BSS specific tone group formation, e.g. how different STA specific tone groups are assigned to different BSSs, is indicated in an Intended BSS Specific Tone Group Formation Type field in a MAP Announcement frame like 500 in FIG. 5A. There are four types of BSS specific tone group formation: (i) dynamic and contiguous formation, (ii) dynamic and non-contiguous formation, (iii) static and contiguous formation, and (iv) static and non-contiguous formation. Further, information of BSS specific tone group can be either explicitly or implicitly indicated in an EHT MB NFRP Trigger frame following the MAP Announcement frame.

In the following paragraphs, a first embodiment of the present disclosure which relates to dynamic and contiguous formation BSS specific tone group formation is explained with reference to APs and STAs for multi-AP based NDP feedback report procedure.

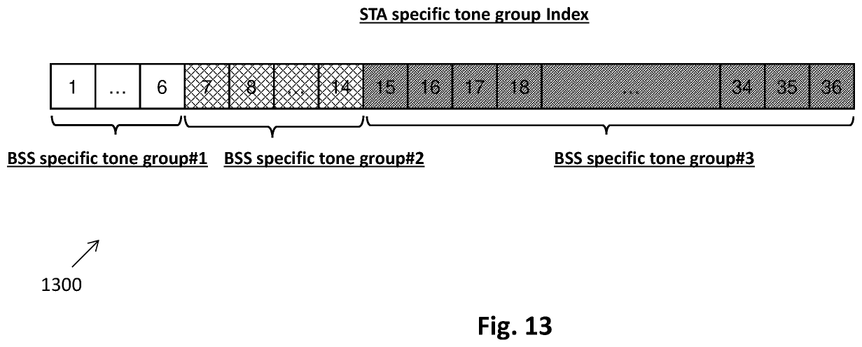

According to the first embodiment of the present disclosure, i.e. dynamic and contiguous BSS specific tone group formation, each BSS specific tone group may comprise different number of STA specific tone groups (dynamic) and the index of STA specific tone groups in each BSS specific tone group is contiguous. FIG. 13 shows an example STA specific tone group formation in a 40 MHz EHT TB Feedback NDP according to the first embodiment of the present disclosure, assuming APs and STAs from 3 BSSs are engaged in multi-AP operation thereby forming a first BSS (BSS#1) with 3 STAs, a second BSS (BSS#2) with 4 STAs and a third BSS (BSS#3) with 8 STAs. In this example, STA specific tone groups from index 1 to index 6 are assigned to BSS#1; STA specific tone groups from index 7 to index 14 are assigned to BSS#2; and STA specific tone groups from index 15 to index 36 are assigned to BSS#3. Advantageously, under the dynamic and contiguous BSS specific tone group formation, STA specific tone groups may be assigned to BSS flexibly based on real situation, for example more STA specific tone groups could be assigned to BSS with more STAs.

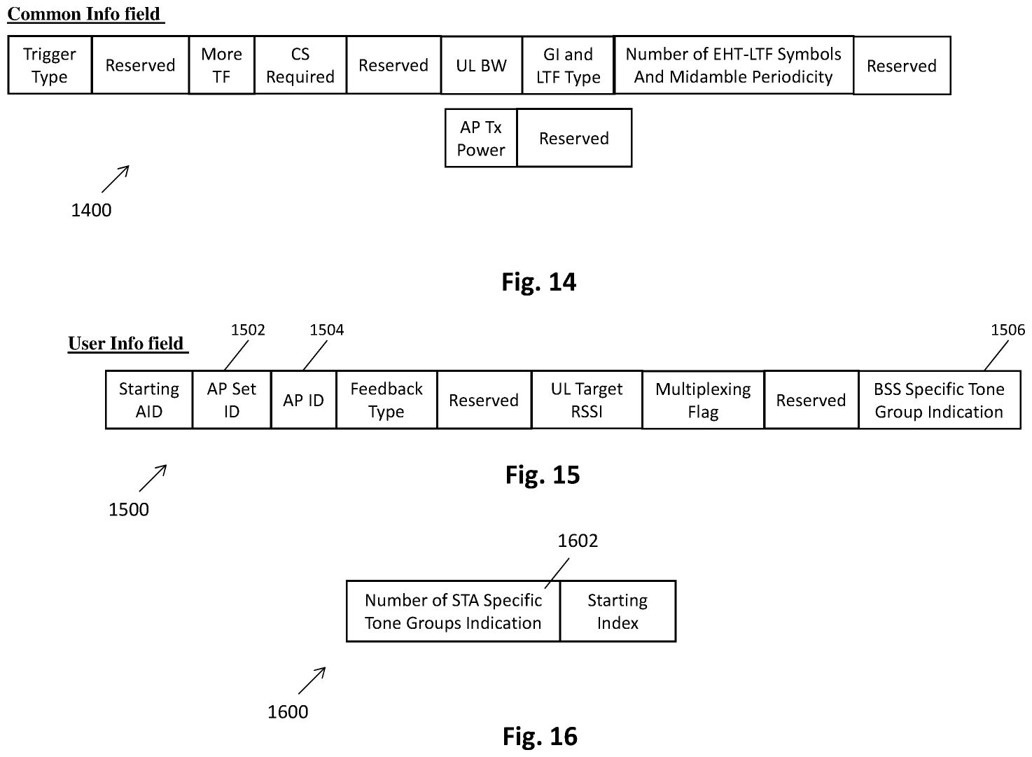

FIG. 14 shows an example format of a Common Info field 1400 of an EHT MB NFRP Trigger frame according to the first embodiment. Similar to the Common Info field 700 of an EHT SB NFRP Trigger frame 700 in FIG. 7, the Common Info field 1400 comprises a Trigger Type subfield, a More TF subfield, a CS Required subfield, a UL BW subfield, a GI and LTF Type subfield, a Number of EHT-LTF Symbols And Midamble Periodicity subfield and a AP Tx Power field.

A User Info List field of an EHT MB NFRP Trigger frame comprises more than one User Info fields. FIG. 15 shows an example format of a User Info field 1500 of an EHT MB NFRP Trigger frame according to the first embodiment. The Trigger Dependent User Info subfield comprises a BSS Specific Tone Group Indication subfield 1506 indicating information about BSS specific tone group to be used by intended STAs to generate an EHT TB Feedback NDP. In one embodiment, the AP Set subfield 1502 and the AP ID 1504 may be replaced by a Short BSSID subfield which indicates a short BSS identifier.

Under the dynamic and contiguous BSS specific tone group formation, the BSS specific tone group used by STAs from each BSS can be explicitly indicated by a BSS Specific Tone Group Indication subfield 1506 of User Info field in an EHT MB NFRP Trigger frame. In an embodiment, the index of STA specific tone groups assigned to a BSS is determined by the information in the BSS Specific Tone Group Indication subfield. FIG. 16 shows an example format of a BSS Specific Tone Group Indication subfield 1600 of a User Info field in an EHT MB NFRP Trigger frame according to the first embodiment. The BSS Specific Tone Group Indication subfield 1600 comprises a Number of STA Specific Tone Groups Indication subfield 1602 and a Starting Index subfield indicating the number and range of STA specific tone groups in the BSS specific tone group, respectively. There are two options for the value used in the Number of STA Specific Tone Groups Indication subfield 1602:

Option 1 and Option 2. Under Option 1, the value of the subfield 1602 is the number of STA specific tone groups in the BSS. Under Option 2, the value of the subfield 1602 indicates the ratio of STA specific tone groups in a BSS to the total number of STA specific tone groups.

For example, where the value of the Number of STA Specific Tone Groups Indication subfield is N, the value of Starting Index is I, BW is the value of UL BW subfield, under Option 1 and Option 2, the index of STA specific tone groups assigned to the BSS could be determined by equations (1) and (2), respectively:

STA_Specific_INDEXε[I,I+N] equation (1)

STA_Specific_INDEXε[I,I+N×18×2^{BW}] equation (2)

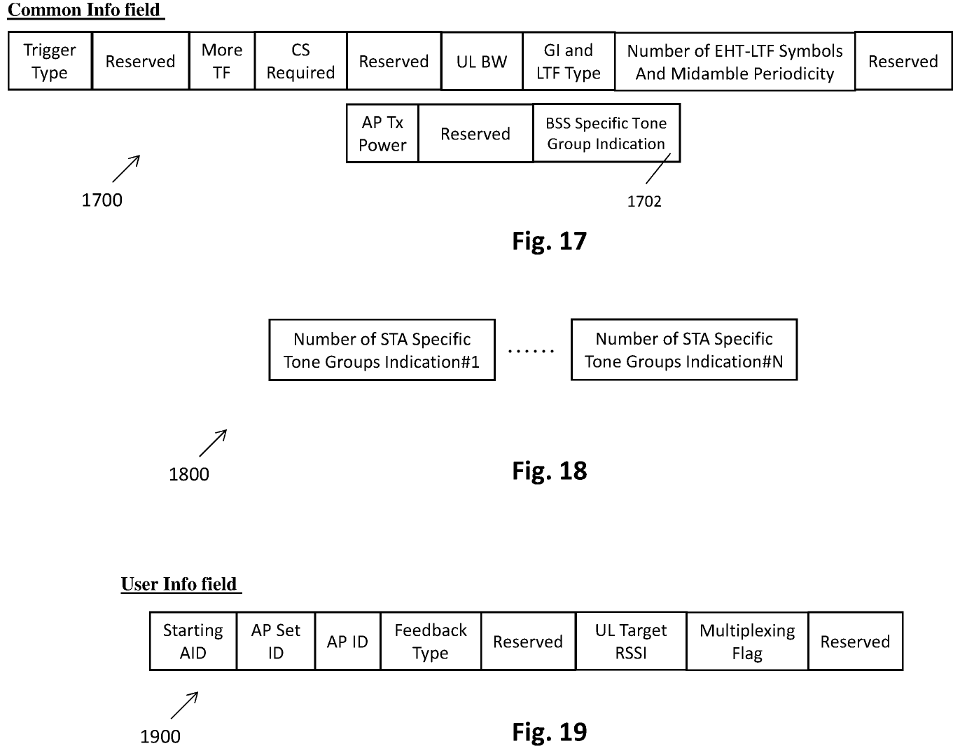

Alternatively, the BSS specific tone group used by STAs from each BSS can be implicitly indicated by a Common Info field and a User Info field of an EHT MB NFRP Trigger frame. FIG. 17 shows another example format of a Common Info field 1700 of an EHT MB NFRP Trigger frame which implicitly indicate BSS specific tone group information according to the first embodiment. The Common Info field 1700 comprises a Trigger Type subfield, a More TF subfield, a CS Required subfield, a UL BW subfield, a GI and LTF Type subfield, a Number of EHT-LTF Symbols And Midamble Periodicity subfield, a AP Tx Power subfield and a BSS Specific Tone Group Indication subfield 1702. The BSS Specific Tone Group Indication subfield 1702 is a Trigger Dependent Common Info subfield of the Common Info field 1700 used to indicate the information about STA specific tone groups assigned to each BSS.

FIG. 18 shows an example format of a BSS Specific Tone Indication subfield 1800 of a Common Info field 1700 in an EHT MB NFRP Trigger frame which implicitly indicate BSS specific tone group information according to the first embodiment. The BSS Specific Tone Group Indication subfield 1800 comprises more than one Number of STA Specific Tone Group Indication subfields. The ordering of the Number of STA Specific Tone Group Indication subfields in BSS Specific Tone Indication subfield 1800 corresponds to the ordering of the User Info subfield in the User Info List field.

There are two options for the value of each Number of STA Specific Tone Groups Indication subfield in the BSS Specific Tone Group Indication subfield 1800: Option 1 and Option 2. Under Option 1, the value of the subfield 1800 is the number of STA specific tone groups in a BSS. Under Option 2, the value of the subfield 1800 indicates the ratio of STA specific tone groups in a BSS to the total number of STA specific tone groups. As such, the information of STA specific tone groups for each BSS, together with the ordering of the corresponding User Info field in User Info List field, determines the index of STA specific tone groups assigned to the BSS.

FIG. 19 shows another example format of a User Info field 1900 of an EHT MB NFRP Trigger frame according to the first embodiment. The Trigger Dependent User Info subfield is not present.

For example, where the value of ith Number of STA Specific Tone Groups Indication subfield is Vⁱ_{indication} (V⁰_{indication}=0), BW is the value of UL BW subfield, under Option 1 and Option 2, the index of STA specific tone groups assigned to a N^{th} BSS (BSS#N) could be determined by equations (3) and (4), respectively:

$$STA\_Specific \_INDEX ∈ \qquad equation ( 3 )$$

$$[ {\sum }_{i = 0}^{N - 1} {V}_{Indication}^{i} + 1 , {\sum }_{i = 1}^{N} {V}_{Indication}^{i} ]$$

$$STA\_Specific \_INDEX ∈ \qquad equation ( 4 )$$

$$[ 18 \times {2}^{BW} \times {\sum }_{i = 0}^{N - 1} {V}_{Indication}^{i} + 1 , 18 \times {2}^{BW} \times {\sum }_{i = 1}^{N} {V}_{Indication}^{i} ]$$

In the following paragraphs, a second embodiment of the present disclosure which relates to dynamic and non-contiguous formation BSS specific tone group formation is explained with reference to APs and STAs for multi-AP based NDP feedback report procedure.

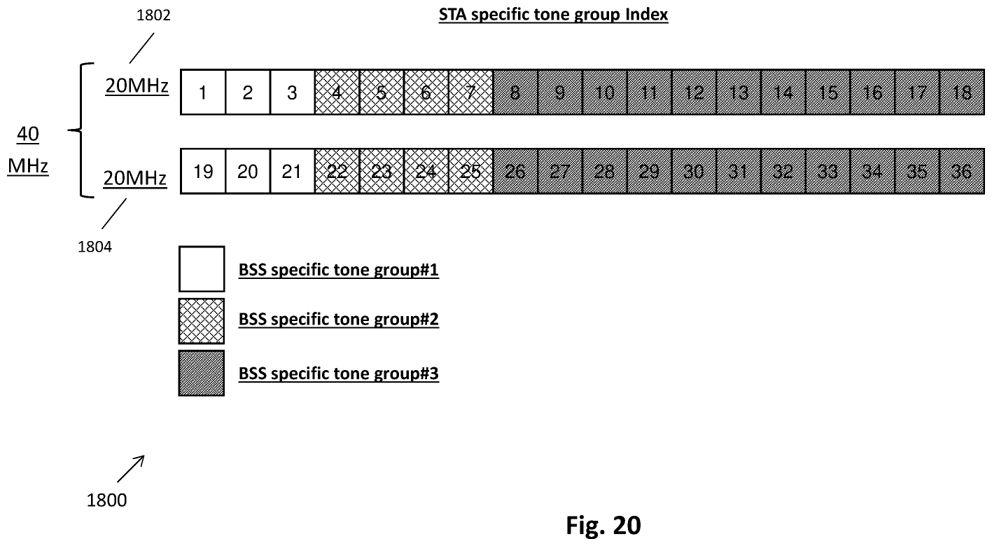

According to the second embodiment of the present disclosure, i.e. dynamic and non-contiguous BSS specific tone group formation, each BSS specific tone group may comprise different number of STA specific tone groups (dynamic) and the index of STA specific tone groups in each BSS specific tone group may be non-contiguous. FIG. 20 shows an example STA specific tone group formation in a 40 MHz EHT TB Feedback NDP according to the second embodiment of the present disclosure, assuming APs and STAs from 3 BSSs are engaged in multi-AP operation thereby forming a first BSS (BSS#1) with 3 STAs, a second BSS (BSS#2) with 4 STAs and a third BSS (BSS#3) with 8 STAs. In this example, STA specific tone groups from index 1 to index 3 corresponding to the first 20 MHz subchannel 1802 and index 19 to index 21 corresponding to the second 20 MHz subchannel 1804 are assigned to BSS#1; STA specific tone groups from index 4 to index 7 corresponding to the first 20 MHz subchannel 1802 and index 22 to index 25 corresponding to the second 20 MHz subchannel 1804 are assigned to BSS#2; and STA specific tone groups from index 8 to index 18 corresponding to the first 20 MHz subchannel 1802 and index 26 to index 36 corresponding to the second 20 MHz subchannel 1804 are assigned to BSS#3. Advantageously, under the dynamic and non-contiguous BSS specific tone group formation, STA specific tone groups may be assigned to BSSs flexibly based on real situation.

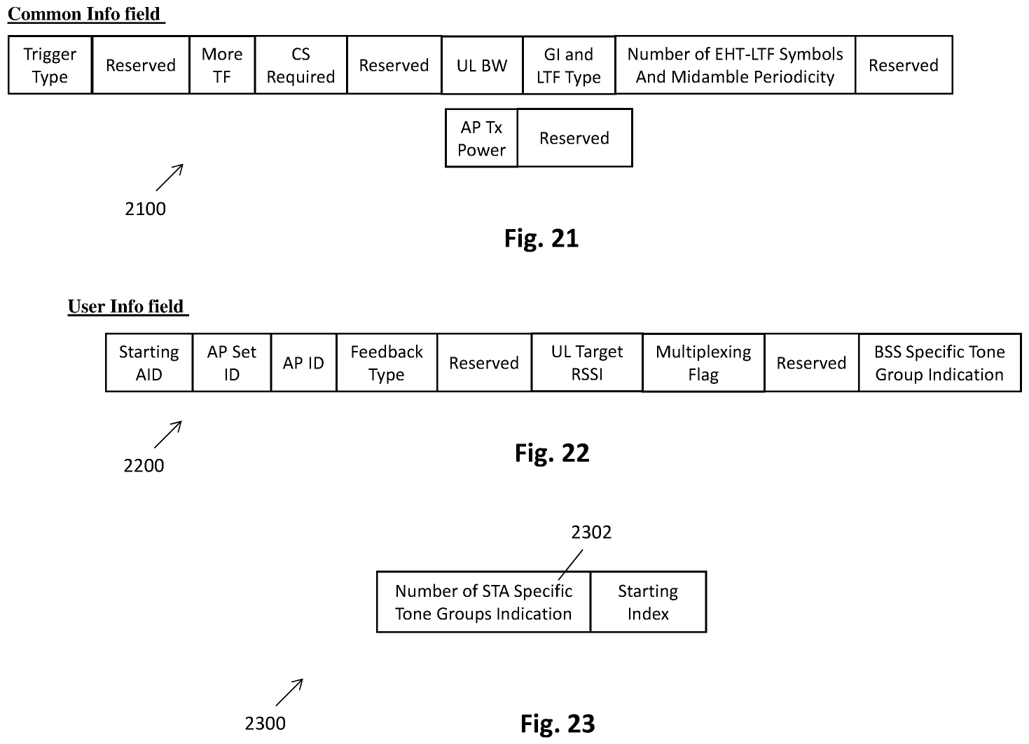

FIG. 21 shows an example format of a Common Info field 2100 of an EHT MB NFRP Trigger frame according to the second embodiment. Similar to the Common Info field 700 of an EHT SB NFRP Trigger frame 700 in FIG. 7, the Common Info field 2100 comprises a Trigger Type subfield, a More TF subfield, a CS Required subfield, a UL BW subfield, a GI and LTF Type subfield, a Number of EHT-LTF Symbols And Midamble Periodicity subfield and a AP Tx Power subfield.

FIG. 22 shows an example format of a User Info field 2200 of an EHT MB NFRP Trigger frame according to the second embodiment. The Trigger Dependent User Info subfield comprises a BSS Specific Tone Group Indication subfield indicating information about BSS specific tone groups to be used by intended STAs to generate an EHT TB Feedback NDP.

Under the dynamic and non-contiguous BSS specific tone group formation, the BSS specific tone group used by STAs from each BSS can be explicitly indicated by a BSS Specific Tone Group Indication subfield of User Info field in an EHT MB NFRP Trigger frame. In an embodiment, the index of STA specific tone groups assigned to a BSS is determined by the information in the BSS Specific Tone Group Indication subfield. FIG. 23 shows an example format of a BSS Specific Tone Group Indication subfield 2300 of a User Info field in an EHT MB NFRP Trigger frame according to the second embodiment. The BSS Specific Tone Group Indication subfield 2300 comprises a Number of STA Specific Tone Groups Indication subfield 2302 and a Starting Index subfield indicating the number and range of STA specific tone groups in the BSS specific tone group of each 20 MHz subchannel, respectively. There are two options for the value used in the Number of STA Specific Tone Groups Indication subfield 2302: Option 1 and Option 2. Under Option 1, the value of the subfield 2302 is the number of STA specific tone groups in the BSS. Under Option 2, the value of the subfield 2302 indicates the ratio of STA specific tone groups in a BSS to the total number of STA specific tone groups.

For example, where the value of the Number of STA Specific Tone Groups Indication subfield is N, the value of Starting Index is I, BW is the value of UL BW subfield, the index of STA specific tone groups assigned to the BSS at each 20 MHz subchannel is determined separately. Under Option 1 and Option 2, The index of STA specific tone groups assigned to the BSS at i^{th} 20 MHz subchannel could be determined by equations (5) and (6), respectively:

STA_Specific_INDEXⁱε[I+(i−1)×18,I+N(i−1)×18] equation (5)

STA_Specific_INDEXⁱε[I+(i−1)×18,I+N×18×2^{BW}+(i−1)×18] equation(6)

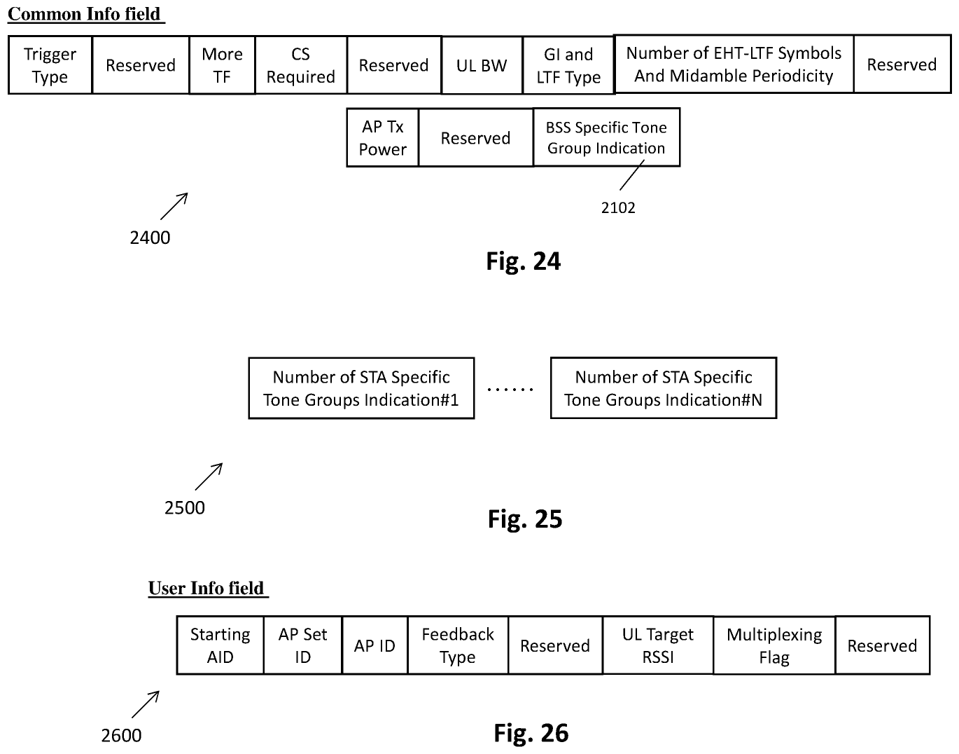

Alternatively, the BSS specific tone group used by STAs from each BSS can be implicitly indicated by a Common Info field and a User Info field of an EHT MB NFRP Trigger frame. FIG. 24 shows another example format of a Common Info field 2400 of an EHT MB NFRP Trigger frame which implicitly indicate BSS specific tone group information according to the second embodiment. The Common Info field 2400 comprises a Trigger Type subfield, a More TF subfield, a CS Required subfield, a UL BW subfield, a GI and LTF Type subfield, a Number of EHT-LTF Symbols And Midamble Periodicity subfield, a AP Tx Power subfield and a BSS Specific Tone Group Indication subfield 2402. The BSS Specific Tone Group Indication subfield 2402 is used to indicate the information about STA specific tone groups assigned to each BSS in each 20 MHz subchannel.

FIG. 25 shows another example format of a BSS Specific Tone Indication subfield 2500 of a Common Info field 2400 in an EHT MB NFRP Trigger frame which implicitly indicate BSS specific tone group information according to the second embodiment. The BSS Specific Tone Group Indication subfield 2500 comprises more than one Number of STA Specific Tone Group Indication subfields. The ordering of the Number of STA Specific Tone Group Indication subfields in BSS Specific Tone Indication subfield 2500 corresponds to the ordering of the User Info subfield in the User Info List field.

There are two options for the value of each Number of STA Specific Tone Groups Indication subfield in the BSS Specific Tone Group Indication subfield 2500: Option 1 and Option 2. Under Option 1, the value of the subfield 2500 is the number of STA specific tone groups in a BSS. Under Option 2, the value of the subfield 2500 indicates the ratio of STA specific tone groups in a BSS to the total number of STA specific tone groups. As such, the information of STA specific tone groups for each

BSS, together with the ordering of the corresponding User Info field in User Info List field, determines the index of STA specific tone groups assigned to the BSS.

FIG. 26 shows another example format of a User Info field 2600 of an EHT MB NFRP Trigger frame according to the second embodiment. The Trigger Dependent User Info subfield is not present.

For example, where the value of ith Number of STA Specific Tone Groups Indication subfield is Vⁱ_{indication} (V⁰_{indication}=0), BW is that value of UL BW subfield, under Option 1 and Option 2, the index of STA specific tone groups assigned to a N^{th} BSS (BSS#N) at i^{th} 20 MHz subchannel could be determined by equations (7) and (8), respectively:

STA_Specifc_INDEXⁱε[Σᵢ₌₀^{N-1}V_{Indication}ⁱ+1,Σᵢ₌₁^{N}V_{Indication}ⁱ]+(i−1)×18 equation (7)

STA_Specifc_INDEXⁱε[18×2^{BW}×Σᵢ₌₀^{N-1}V_{Indication}ⁱ+1,18×2^{BW}×Σᵢ₌₁^{N}V_{Indication}ⁱ]+(i−1)×18 equation (8)

In the following paragraphs, a third embodiment of the present disclosure which relates to static and contiguous formation BSS specific tone group formation is explained with reference to APs and STAs for multi-AP based NDP feedback report procedure.

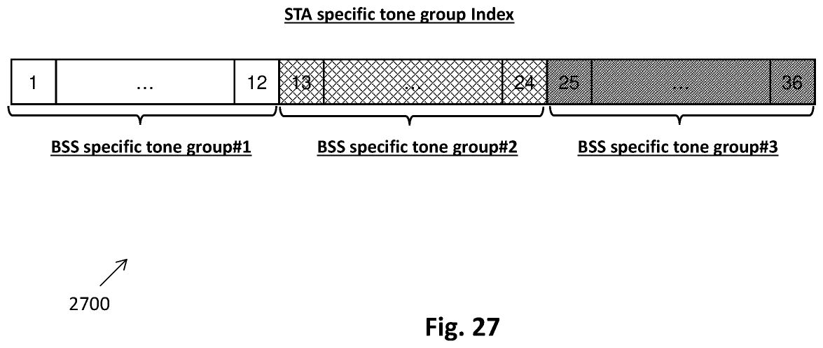

According to the third embodiment of the present disclosure, i.e. static and contiguous BSS specific tone group formation, each BSS specific tone group may comprise same number of STA specific tone groups (static) and the index of STA specific tone groups in each BSS specific tone group may be contiguous. FIG. 27 shows an example STA specific tone group formation in a 40 MHz EHT TB Feedback NDP according to the third embodiment of the present disclosure, assuming APs and STAs from 3 BSSs are engaged in multi-AP operation thereby forming a first BSS (BSS#1) with 3 STAs, a second BSS (BSS#2) with 4 STAs and a third BSS (BSS#3) with 8 STAs. In this example, STA specific tone groups from index 1 to index 12 are assigned to BSS#1; STA specific tone groups from index 13 to index 24 are assigned to BSS#2; and STA specific tone groups from index 25 to index 36 are assigned to BSS#3. Advantageously, under the static and contiguous BSS specific tone group formation, this requires less signaling overhead than the first embodiment.

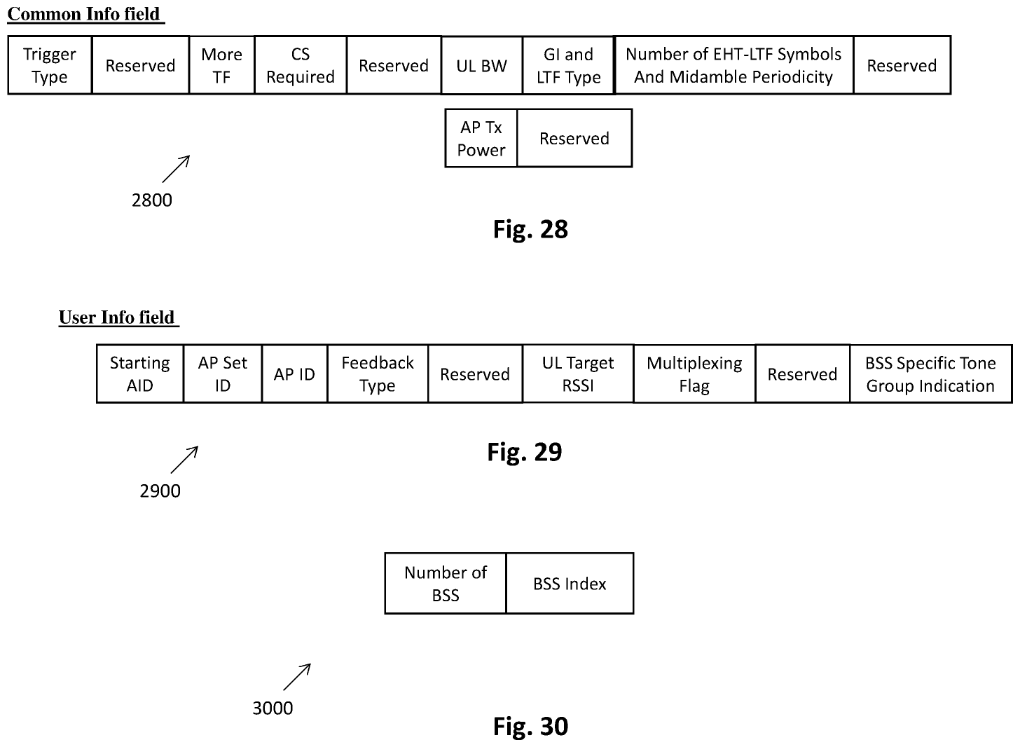

FIG. 28 shows an example format of a Common Info field 2800 of an EHT MB NFRP Trigger frame according to the third embodiment. Similar to the Common Info field 700 of an EHT SB NFRP Trigger frame 700 in FIG. 7, the Common Info field 2800 comprises a Trigger Type subfield, a More TF subfield, a CS Required subfield, a UL BW subfield, a GI and LTF Type subfield, a Number of EHT-LTF Symbols And Midamble Periodicity subfield and a AP Tx Power subfield.

FIG. 29 shows an example format of a User Info field 2900 of an EHT MB NFRP Trigger frame according to the third embodiment. The Trigger Dependent User Info subfield comprises a BSS Specific Tone Group Indication subfield indicating information about BSS specific tone group to be used by intended STAs to generate an EHT TB Feedback NDP.

Under the static and contiguous BSS specific tone group formation, the BSS specific tone group used by STAs from each BSS can be explicitly indicated by a BSS Specific Tone Group Indication subfield of User Info field 2900 in an EHT MB NFRP Trigger frame. In an embodiment, the index of STA specific tone groups assigned to a BSS is determined by the information in the BSS Specific Tone Group Indication subfield. FIG. 30 shows an example format of a BSS Specific Tone Group Indication subfield 3000 of a User Info field in an EHT MB NFRP Trigger frame according to the third embodiment. The BSS Specific Tone Group Indication subfield 3000 comprises a Number of BSS subfield and a BSS Index subfield indicating the total number of BSSs and the BSS index respectively.

For example, where the value of the Number of BSS subfield is N_{BSS}, the value of BSS Index subfield is N, BW is the value of UL BW subfield, the index of STA specific tone groups assigned to the N^{th} BSS (BSS#N) could be determined by equation (9):

$$STA\_Specific \_INDEX ∈ \qquad equation ( 9 )$$

$$[ ( N - 1 ) \times ⌊ \frac{18 \times {2}^{BW}}{{N}_{BSS}} ⌋ + 1 , N \times ⌊ \frac{18 \times {2}^{BW}}{{N}_{BSS}} ⌋ ]$$

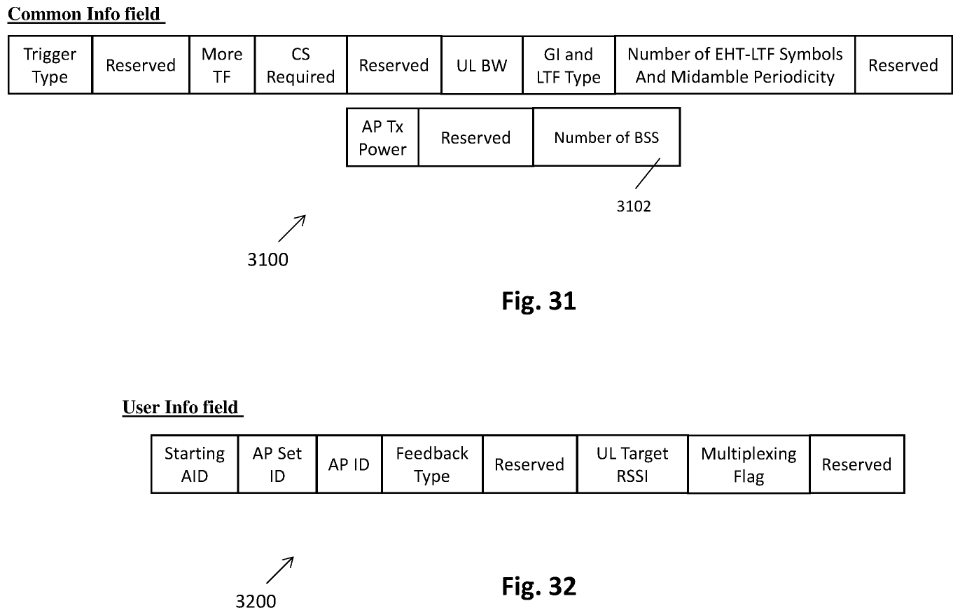

Alternatively, the BSS specific tone group used by STAs from each BSS can be implicitly indicated by a Common Info field and a User Info field of an EHT MB NFRP Trigger frame. FIG. 31 shows another example format of a Common Info field 3100 of an EHT MB NFRP Trigger frame which implicitly indicate BSS specific tone group information according to the third embodiment. The Common Info field 3100 comprises a Trigger Type subfield, a More TF subfield, a CS Required subfield, a UL BW subfield, a GI and LTF Type subfield, a Number of EHT-LTF Symbols And Midamble Periodicity subfield, a AP Tx Power subfield and a Number of BSS subfield 3102. The Number of BSS subfield 3102 is used to indicate the number of BSSs.

FIG. 32 shows another example format of a User Info field 3200 of an EHT MB NFRP Trigger frame according to the third embodiment. The Trigger Dependent User Info subfield is not present. The value of Number of BSS subfield 3102, together with the ordering of the corresponding User Info field in User Info List field, determines the index of STA specific tone groups assigned to the BSS. For example, where the value of the Number of BSS subfield is N_{BSS}, the ordering of the corresponding User Info field in User Info List field is N, BW is the value of UL BW subfield, the index of STA specific tone groups assigned to the Nth BSS (BSS#N) could be determined by equation (10):

$$STA\_Specific \_INDEX ∈ \qquad equation ( 10 )$$

$$[ ( N - 1 ) \times ⌊ \frac{18 \times {2}^{BW}}{{N}_{BSS}} ⌋ + 1 , N \times ⌊ \frac{18 \times {2}^{BW}}{{N}_{BSS}} ⌋ ]$$

In the following paragraphs, a fourth embodiment of the present disclosure which relates to static and non-contiguous formation BSS specific tone group formation is explained with reference to APs and STAs for multi-AP based NDP feedback report procedure.

According to the fourth embodiment of the present disclosure, i.e. static and non-contiguous BSS specific tone group formation, each BSS specific tone group may comprise same number of STA specific tone groups (static) and the index of STA specific tone groups in each BSS specific tone group may be non-contiguous.

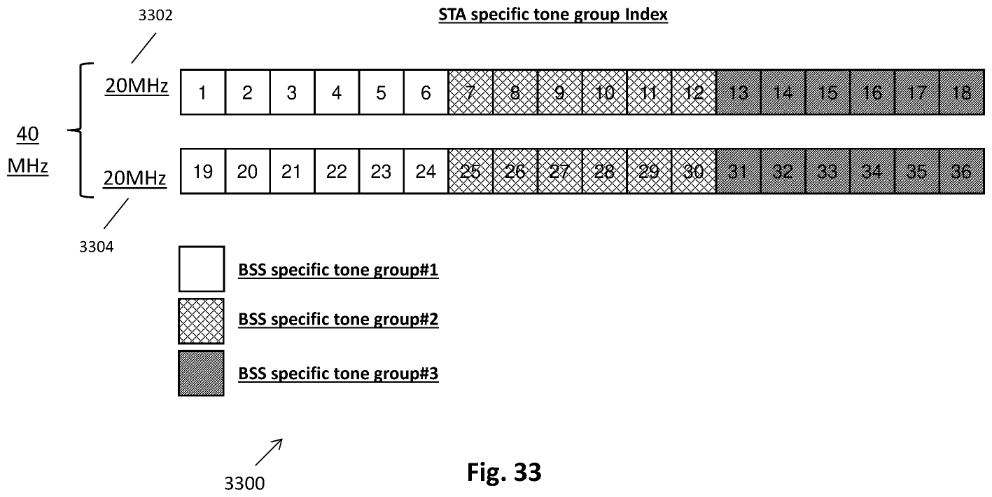

FIG. 33 shows an example STA specific tone group formation in a 40 MHz EHT TB Feedback NDP according to the fourth embodiment of the present disclosure, assuming APs and STAs from 3 BSSs are engaged in multi-AP operation thereby forming a first BSS (BSS#1) with 3 STAs, a second BSS (BSS#2) with 4 STAs and a third BSS (BSS#3) with 8 STAs. In this example, STA specific tone groups from index 1 to index 6 corresponding to the first 20 MHz subchannel 3302 and index 19 to index 24 corresponding to the second 20 MHz subchannel 3304 are assigned to BSS#1; STA specific tone groups from index 7 to index 12 corresponding to the first 20 MHz subchannel 3302 and index 25 to index 30 corresponding to the second 20 MHz subchannel 3304 are assigned to BSS#2; and STA specific tone groups from index 13 to index 18 corresponding to the first 20 MHz subchannel 3302 and index 31 to index 36 corresponding to the second 20 MHz subchannel 3304 are assigned to BSS#3. Advantageously, under the static and non-contiguous BSS specific tone group formation, this requires less signaling overhead than the second embodiment.

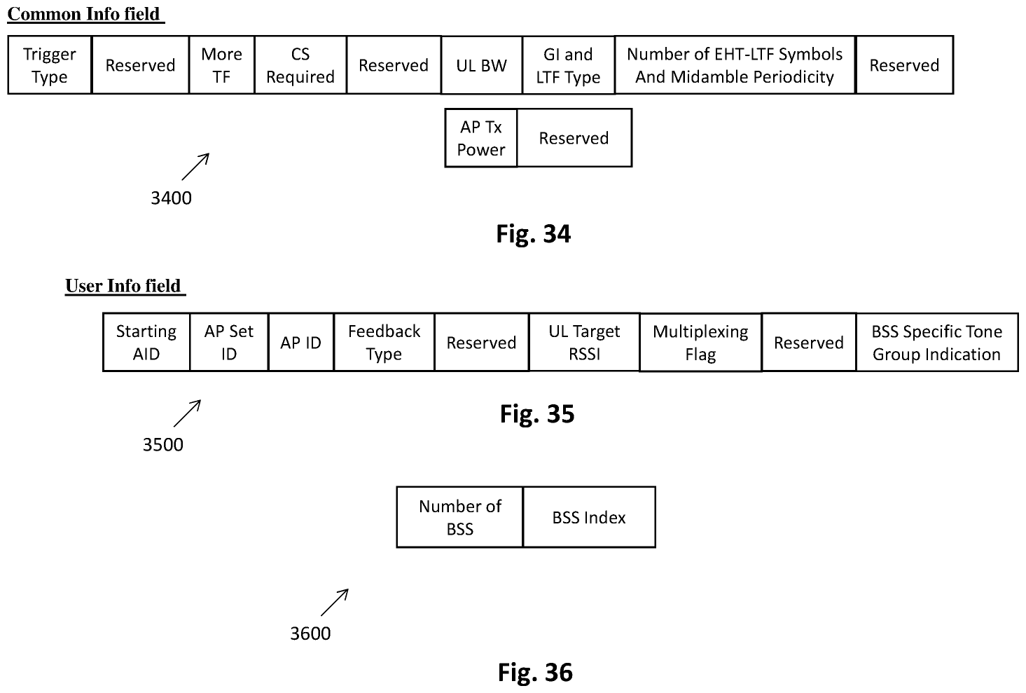

FIG. 34 shows an example format of a Common Info field 3400 of an EHT MB NFRP Trigger frame according to the fourth embodiment. Similar to the Common Info field 700 of an EHT SB NFRP Trigger frame 700 in FIG. 7, the Common Info field 3400 comprises a Trigger Type subfield, a More TF subfield, a CS Required subfield, a UL BW subfield, a GI and LTF Type subfield, a Number of EHT-LTF Symbols And Midamble Periodicity subfield and a AP Tx Power subfield.

FIG. 35 shows an example format of a User Info field 3500 of an EHT MB NFRP Trigger frame according to the fourth embodiment. The Trigger Dependent User Info subfield comprises a BSS Specific Tone Group Indication subfield indicating information about BSS specific tone group to be used by intended STAs to generate an EHT TB Feedback NDP.

Under the static and non-contiguous BSS specific tone group formation, the BSS specific tone group used by STAs from each BSS can be explicitly indicated by a BSS Specific Tone Group Indication subfield of User Info field 3500 in an EHT MB NFRP Trigger frame. In an embodiment, the index of STA specific tone groups assigned to a BSS is determined by the information in the BSS Specific Tone Group Indication subfield. FIG. 36 shows an example format of a BSS Specific Tone Group Indication subfield 3600 of a User Info field in an EHT MB NFRP Trigger frame according to the fourth embodiment. The BSS Specific Tone Group Indication subfield 3600 comprises a Number of BSS subfield and a BSS Index subfield indicating the total number of BSSs and the BSS index respectively.

For example, where the value of the Number of BSS subfield is N_{BSS}, the value of BSS Index subfield is N, BW is the value of UL BW subfield, the index of STA specific tone groups assigned to the N^{th} BSS (BSS#N) at ith 20 MHz subchannel could be determined by equation (11):

$$STA\_Specific {\_INDEX}^{i} ∈ \qquad equation ( 11 )$$

$$[ ( N - 1 ) \times ⌊ \frac{18 \times {2}^{BW}}{{N}_{BSS}} ⌋ + 1 , N \times ⌊ \frac{18 \times {2}^{BW}}{{N}_{BSS}} ⌋ ] + ( i - 1 ) \times 18$$

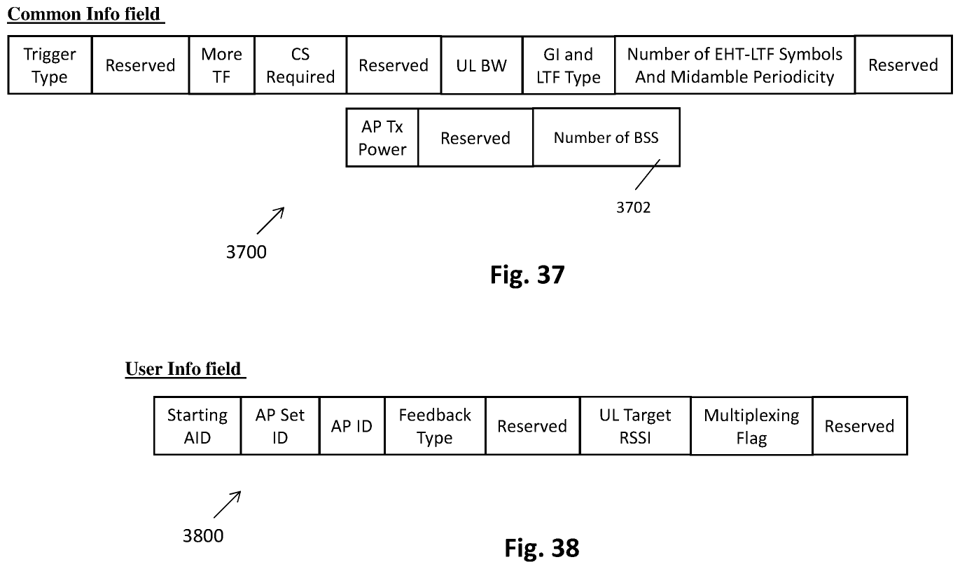

Alternatively, the BSS specific tone group used by STAs from each BSS can be implicitly indicated by a Common Info field and a User Info field of an EHT MB NFRP Trigger frame. FIG. 37 shows another example format of a Common Info field 3700 of an EHT MB NFRP Trigger frame which implicitly indicate BSS specific tone group information according to the fourth embodiment. The Common Info field 3700 comprises a Trigger Type subfield, a More TF subfield, a CS Required subfield, a UL BW subfield, a GI and LTF Type subfield, a Number of EHT-LTF Symbols And Midamble Periodicity subfield, a AP Tx Power subfield and a Number of BSS subfield 3702. The Number of BSS subfield 3702 is used to indicate the number of BSSs.

FIG. 38 shows another example format of a User Info field 3800 of an EHT MB NFRP Trigger frame according to the fourth embodiment. The Trigger Dependent User Info subfield is not present.

The value of Number of BSS subfield 3002, together with the ordering of the corresponding User Info field in User Info List field, determines the index of STA specific tone groups assigned to the BSS. For example, where the value of the Number of BSS subfield is N_{BSS}, the ordering of the corresponding User Info field in User Info List field is N, BW is the value of UL BW subfield, the index of STA specific tone groups assigned to the N^{th} BSS (BSS#N) at i^{th} 20 MHz subchannel could be determined by equation (12):

$$STA\_Specific {\_INDEX}^{i} ∈ \qquad equation ( 12 )$$

$$[ ( N - 1 ) \times ⌊ \frac{18 \times {2}^{BW}}{{N}_{BSS}} ⌋ + 1 , N \times ⌊ \frac{18 \times {2}^{BW}}{{N}_{BSS}} ⌋ ] + ( i - 1 ) \times 18$$

According to the present disclosure, regardless of the intended type of BSS specific tone group formation, a STA is scheduled to respond to the EHT MB MFRP

Trigger frame corresponding to multi-AP operation if the STA is associated with a BSS for which a User Info field intends, and the STA's AID is greater than or equal to the starting AID and less than starting AID+N_{STA}, using the starting AID subfield in the User Info field for a BSS which the STA is associated with, and the total number of STAs (N_{STA}) that are scheduled to respond to the EHT MB NFRP Trigger frame.

In an embodiment, the N_{STA} is calculated using the BSS Specific Tone Group Indication subfield and Multiplexing Flag subfield from the EHT MB NFRP Trigger frame based on equation (13):

N_{STA}=N_{STA_Specific_TG}×(Multiplexing flag+1) equation (13)

where N_{STA_Specific_TG} is the number of STA specific tone groups assigned to the BSS.

A STA generates a NDP feedback report response using an EHT TB Feedback NDP. In an embodiment, only 4× HE-LTF sequence shall be used to generate an EHT-LTF field of the EHT TB Feedback NDP. In another embodiment, a 4× EHT-LTF sequence is used to generate an EHT-LTF field of the EHT TB Feedback NDP using equation (14):

$${EHTLTF}_{k , u}^{TB \_ NDP} = \{ \begin{matrix}{EHTLTF}_{k} , & if k ∈ {K}_{{tone}_{NDPu}} \\ 0 , & otherwise\end{matrix} \qquad equation ( 14 )$$

where EHTLTFₖ is the value of the common 4× EHT-LTF sequence on subcarrier k generated according to the channel bandwidth; Kₜₒₙₑ_{_{NDPu}} is the set of subcarrier indices for user u and is defined in tables of EHT-LTF subcarrier mapping for the EHT TB Feedback NDP according to the RU_TONE_SET_INDEX and FEEDBACK_STATUS. The RU_TONE_SET_INDEX parameter shall be set using equation (15):

RU_TONE_SET_INDEX=STA_Specific_INDEX((AID−Starting AID)mod(N_{STA_specific_TG})) equation (15)

where STA_Specific_INDEX is the index of STA specific tone groups in the BSS specific tone group. The tables of HE-LTF subcarrier mapping for the HE TB Feedback NDP can be reused for mapping the EHT-LTF subcarriers in the EHT TB Feedback NDP.

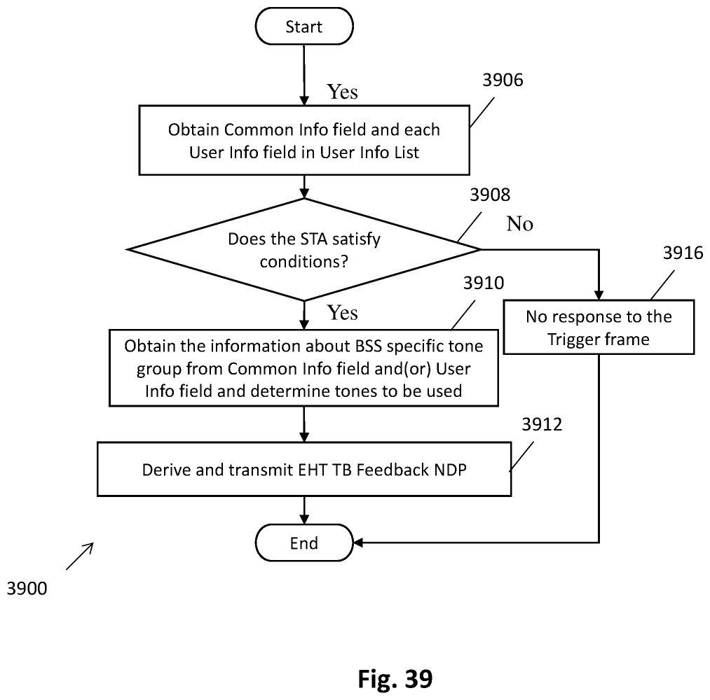

FIG. 39 shows a flow chart illustrating a procedure carried out by a STA when receiving an EHT MB NFRP Trigger frame from an AP according to an embodiment. In step 3906, information from the Common Info field and each of the User Info field of the User Info List field is obtained. In step 3908, it is determined if the STA satisfies conditions, for example if the STA is associated with a BSS for which a User Info field intends, and if the STA's AID is greater than or equal to the starting AID and less than starting AID+N_{STA} based on obtained information. If the STA satisfies conditions, step 3910 is carried out. Otherwise, step 3916 is carried out where no response to the EHT MB NFRP Trigger frame is generated. In step 3910, the information about BSS specific tone group is obtained from the Common Info field and/or the User Info field, and the tones to be used are determined from the obtained information. In step 3912, the STA then derives and transmits EHT TB Feedback NDP, and the process may end.

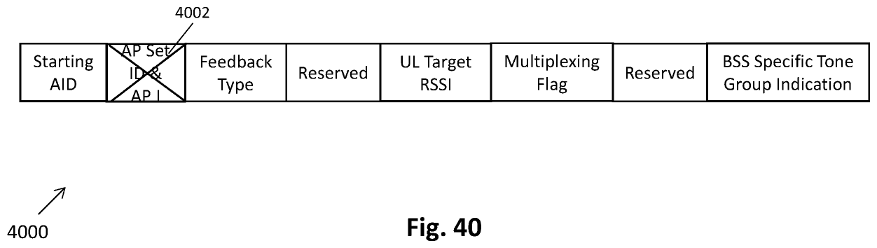

FIG. 40 shows an example format of a User Info field 4000 according to yet another embodiment of the present disclosure. According to an embodiment of the present disclosure, APs may plan non-overlapping AID spaces between coordinated APs, and with different and non-overlapping AIDs assigned to STAs from different BSSs, the indication of BSS identifier in EHT MB NFRP Trigger frame is not needed, as indicated in 4002. As such, in this embodiment, the User Info field 4000 comprises a Starting AID subfield, a Feedback Type subfield, a UL Target RSSI subfield, a Multiplexing Flag subfield and a BSS Specific Tone Group Indication subfield. The AP Set ID and the AP ID may be reserved. This can be achieved by generating a coordination frame prior to generation of the first frame (for example MAP Announcement frame) to initiate a NDP feedback report procedure, for example at the formation procedure of multi-AP coordination set. The entire space and the sharing AID assignment status may be shared across coordinated AP set using the coordination frame prior to generation of the first frame for multi-AP based NDP feedback report procedure. It is noted that the usage of NFRP Trigger frame comprising more than one User Info field is not limited to multi-AP operation. It is further noted that the number of AIDs assigned to STAs from a BSS should be larger than the number of STAs that is able to be supported by the BSS.

In this embodiment, intended STAs are identified by the starting AID and the number of STAs. A STA is scheduled to respond if the STA satisfies a condition, for example if the STA's AID is greater than or equal to any starting AID indicated in User Info field and less than starting AID+N_{STA}.

For example, where AID 1-1000 is assigned to STAs from a first BSS (BSS#1), AID 1001-2000 is assigned to STAs from a second BSS (BSS#2), the number of STAs is 36, starting AID indicated in the 1^{st} User Info field is 1, and starting AID indicated in the 2^{nd} User Info field is 1001, the first Starting AID+N_{STA} (Starting AID#1+N_{STA}) for BSS1 and the second Starting AID+N_{STA} (Starting AID#2+N_{STA}) for BSS2 can be calculated as 37 (1+36) and 1037 (1001+36), respectively. In this example, if an AID of a STA (from BSS#2) is 1003, as the AID of the STA is greater than the second Starting AID and less than the second Starting AID+N_{STA}, the STA is determined to fulfil the condition, and thus is schedule, and the 2^{nd} User Info field is for the STA.

As mentioned above, according to the present disclosure, under BSS specific tone group formation option 2, tones correspond to a STA specific tone group may not belong to a same 20 MHz subchannel. In an embodiment, the tones in each STA specific tone group depend on the bandwidth of EHT TB Feedback NDP. Table 3 shows an example STA specific tone group formation in 40 MHz EHT TB Feedback NDP (Option 2). In this example, 36 STA specific tone groups, each of which comprises 12 STA specific tones, are formed. Further, each of the 12 STA specific tones of a STA specific tone group comprises two subgroups of six tones which indicate different feedback information, in this case feedback status of 1 or 0 respectively. In addition, each subgroup of six STA specific tones may belong to a different 20 MHz subchannels. For example, STA specific tone group 1 (index=1) comprises 12 STA specific tones, e.g. −241, −240, −205, −204, −169, −168 from the first 20 MHz subchannel and 15, 16, 51, 52, 87, 88 from the second 20 MHz subchannel. Six of the STA specific tones, e.g. −241, −205, −169 from the first 20 MHz subchannel and 15, 51, 87 from the second 20 MHz, are used to indicate a feedback status of 1 and the remaining six, e.g. −240, −204, −168 from the first 20 MHz subchannel and 16, 52, 88 from the second 20 MHZ subchannel are used to indicate a feedback status of 0. Advantageously, under option 2 with STA specific tone group across multiple 20 MHz subchannels, the frequency diversity can be further improved.

TABLE 2
An example STA specific tone group formation in a
20 MHz EHT TB Feedback NDP.

| STA | | |
|---|---|---|
| specific | | |
| tone group | STA specific tones when | STA specific tones when |
| Index | feedback status = 1 | feedback status = 0 |
| 1 | −241, −205, −169 (from the | −240, −204, −168 (from the |
| | first 20 MHz subchannel) | first 20 MHz subchannel) |
| | 15, 51, 87 (from the second | 16, 52, 88 (from the second |
| | 20 MHz subchannel) | 20 MHz subchannel) |
| . . . | . . . | . . . |
| 36 | −207, −171, −135 (from the | −206, −170, −134 (from the |
| | first 20 MHz subchannel) | first 20 MHz subchannel) |
| | 168, 204, 240 (from the | 169, 205, 241 (from the |
| | second 20 MHz subchannel) | second 20 MHz subchannel) |

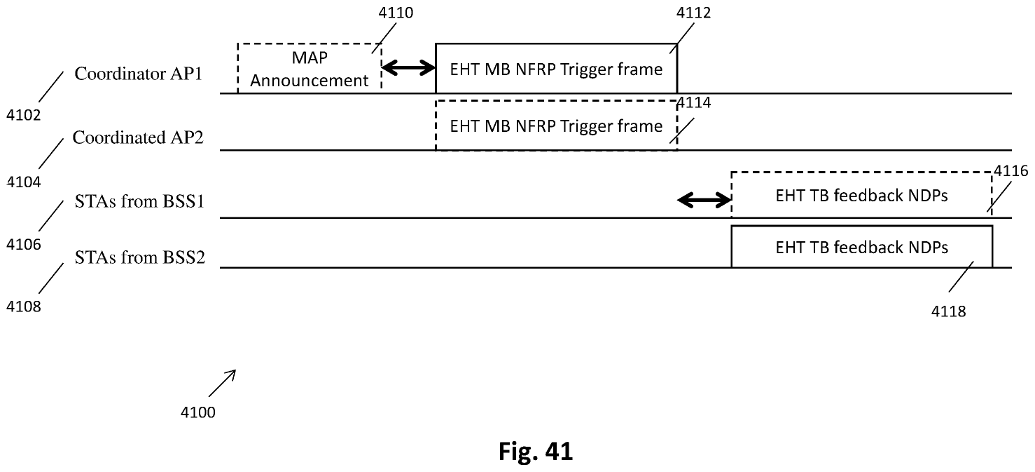

FIG. 41 shows a flow diagram illustrating communications of a multi-AP based NDP feedback report procedure according to yet another embodiment of the present disclosure, where the EHT MB NFRP Trigger frames may not be simultaneously transmitted or the transmission is not initiated by a MAP Announcement frame.

In this embodiment, a first AP (coordinator AP1) 4102 may belong to BSS1 and is associated with STAs from BSS1 4106 while a second AP (coordinated AP2) 4104 may belong to BSS2 and is associated with STAs from BSS2 4108. Assuming an AP set comprising the coordinator AP1 4102 and the coordinated AP2 4104 is defined/negotiated in advance, at least one AP, such as the coordinator AP1 4102, in the AP set transmits an EHT MB NFRP Trigger frame 4112 soliciting a feedback from a STA which is associated with another AP, for example EHT TB Feedback NDPs 4118 from the STAs from BSS2 4108 which is associated with the coordinated AP2 4104, but within reachable range from the coordinator AP1 4102 in the AP set. The EHT MB NFRP Trigger frame sent by the AP, such as the coordinator AP1 4102 may also at the same time solicit a feedback from a STA which is associated with the AP, for example EHT TB Feedback NDPs 4116 from the STAs from BSS1 4106 which is associated with the coordinator AP1 4102. Accordingly, in this embodiment, an EHT MB NFRP Trigger frame 4114 from other APs such as AP 4104, and thus a MAP Announcement frame 4110 from the coordinator AP 4102 are not required.

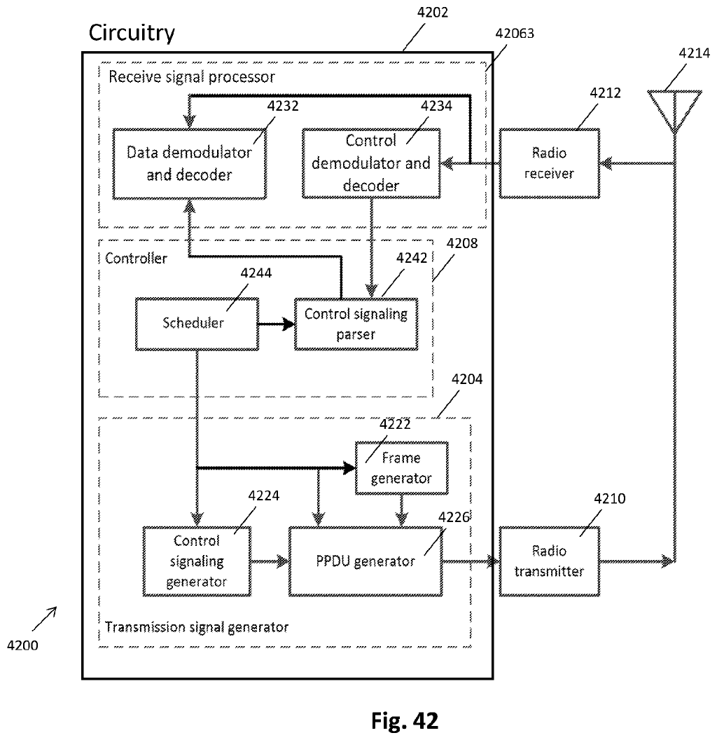

FIG. 42 shows a configuration of a communication device, for example an AP, according to the present disclosure. Similar to the schematic example of the communication apparatus 1100 shown in FIG. 11, the communication apparatus 4200 includes circuitry 4202, at least one radio transmitter 4210, at least one radio receiver 4212, at least one antenna 4214 (for the sake of simplicity, only one antenna is depicted in FIG. 42). The circuitry 4202 may include at least one controller 4208 for use in software and hardware aided execution of tasks that the controller 4208 is designed to perform communication for NDP feedback report. The circuitry 4202 may further include a transmission signal generator 4204 and a receive signal processor 4206. The at least one controller 4208 may control the transmission signal generator 4204 and the receive signal processor 4206. The transmission signal generator 4204 may include a frame generator 4222, a control signaling generator 4224, and a PPDU generator 4226. The frame generator 4222 may generate MAC frames, e.g. MAP Announcement frames or EHT Trigger frames. The control signaling generator 4224 may generate control signaling fields of PPDUs to be generated (e.g. U-SIG fields and EHT-SIG fields of EHT MU PPDUs). The PPDU generator 4226 may generate PPDUs (e.g. EHT MU PPDUs).

The receive signal processor 4206 may include a data demodulator and decoder 4234, which may demodulate and decode data portions of the received signals (e.g. data fields of EHT MU PPDUs). The receive signal processor 4206 may further include a control demodulator and decoder 4234, which may demodulate and decode control signaling portions of the received signals (e.g. U-SIG fields of EHT TB Feedback NDPs or U-SIG fields and EHT-SIG fields of EHT MU PPDUs). The at least one controller 4208 may include a control signal parser 4242 and a scheduler 4244. The scheduler 4244 may determine RU information and user-specific allocation information for allocations of downlink SU or MU transmissions and triggering information for allocations of uplink MU transmissions. The control signal parser 4242 may analyse the control signaling portions of the received signals and the triggering information for allocations of uplink MU transmissions shared by the scheduler 4244 and assist the data demodulator and decoder 4232 in demodulating and decoding the data portions of the received signals.

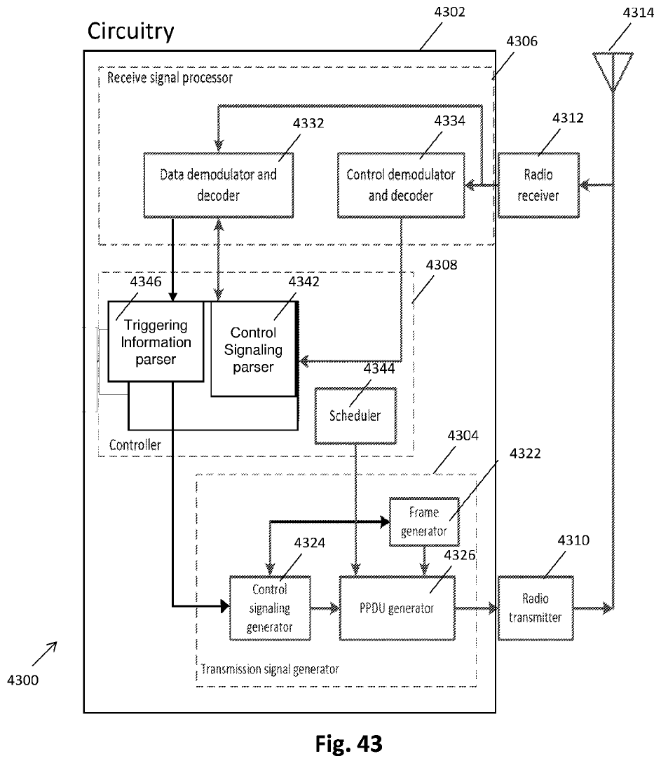

FIG. 43 shows a configuration of a communication device, for example an STA, according to the present disclosure. Similar to the schematic example of communication apparatus 1100 shown in FIG. 11, the communication apparatus 4300 includes circuitry 4302, at least one radio transmitter 4310, at least one radio receiver 4312, at least one antenna 4314 (for the sake of simplicity, only one antenna is depicted in FIG. 43). The circuitry 4302 may include at least one controller 4308 for use in software and hardware aided execution of tasks that the controller 4308 is designed to perform communication for NDP feedback report. The circuitry 4302 may further include a receive signal processor 4304 and a transmission signal generator 4306. The at least one controller 4308 may control the receive signal processor 4304 and the transmission signal generator 4306. The receive signal processor 4304 may include a data demodulator and decoder 4332 and a control demodulator and decoder 4334. The control demodulator and decoder 4334 may demodulate and decode control signaling portions of the received signals (e.g. U-SIG fields and EHT-SIG fields of EHT MU PPDUs). The data demodulator and decoder 4332 may demodulate and decode data portions of the received signals (e.g. data fields of EHT MU PPDUs) according to RU information and user-specific allocation information of its own allocations.

The at least one controller 4308 may include a control signal parser 4342, and a scheduler 4344 and a trigger information parser 4346. The control signal parser 4342 may analyze the control signaling portions of the received signals (e.g. U-SIG field and EHT-SIG fields of EHT MU PPDUs) and assist the data demodulator and decoder 4332 in demodulating and decoding the data portions of the received signals (e.g. data fields of EHT MU PPDUs). The triggering information parser 4348 may analyze the triggering information for its own uplink allocations from the received triggering frames contained in the data portions of the received signals. The transmission signal generator 4304 may include a control signalling generator 4324, which may generate control signalling fields of PPDUs to be generated (e.g. U-SIG fields of EHT TB Feedback NDPs or U-SIG fields and EHT-SIG fields of EHT MU PPDUs). The transmission signal generator 4304 may further include a PPDU generator 4326, which generate PPDUs (e.g. EHT TB Feedback NDPs or EHT MU PPDUs). The transmission signal generator 4304 may further include a frame generator 4322 may generate MAC frames.

As described above, the embodiments of the present disclosure provide an advanced communication system, communication methods and communication apparatuses for multi-AP based NDP feedback report in MIMO WLAN networks and improve spectral efficiency in MIMO WLAN networks.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such a communication apparatus include a phone (e.g. cellular (cell) phone, smart phone), a tablet, a personal computer (PC) (e.g. laptop, desktop, netbook), a camera (e.g. digital still/video camera), a digital player (digital audio/video player), a wearable device (e.g. wearable camera, smart watch, tracking device), a game console, a digital book reader, a telehealth/telemedicine (remote health and medicine) device, and a vehicle providing communication functionality (e.g. automotive, airplane, ship), and various combinations thereof.

The communication apparatus is not limited to be portable or movable, and may also include any kind of apparatus, device or system being non-portable or stationary, such as a smart home device (e.g. an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1. A communication apparatus comprising:
circuity, which, in operation, generates a first frame to initiate a null data packet (NDP) feedback report procedure; and
a transmitter, which, in operation, transmits the first frame to one or more peer communication apparatuses, wherein the first frame comprises a first field indicating an intended type of NDP feedback report procedure.

2. The communication apparatus according to claim 1, wherein the first field of the first frame indicates that a second frame of the communication apparatus and respective frame(s) of the one or more peer communication apparatuses are to be simultaneously transmitted, the first frame comprising a second field indicating an intended manner to assign a plurality of tones to one or more basic service sets (BSSs).

3. The communication apparatus according to claim 1, wherein the circuity, in operation, generates a second frame to solicit a NDP feedback report.

4. The communication apparatus according to claim 3, wherein the second frame comprises a first field indicating an alignment of the NDP feedback report.

5. The communication apparatus according to claim 3, wherein the second frame comprises a second field indicating an index of tones assigned to one or more BSSs.

6. The communication apparatus according to claim 1, wherein, prior to the generation of the first frame, the circuity, which, in operation, generates a coordination frame indicating a range of identifiers of intended communication apparatuses corresponding to one or more BSSs; and the transmitter, which, in operation, transmits the coordination frame to the one or more peer communication apparatuses.

7. The communication apparatus according to claim 2, wherein the plurality of tones assigned to an intended communication apparatus in one of the one or more BSSs belongs to one or more 20 MHz frequency segments.

8. The communication apparatus according to claim 3, wherein, when the second frame is suitable to be transmitted to one or more intended communication apparatuses associated with one of the one or more peer communication apparatuses, the second frame is generated without the generation of the first frame to solicit the NDP feedback report from the one or more intended communication apparatuses.

9. A peer communication apparatus comprising:
a receiver, which, in operation, receives a first frame from a communication apparatus to initiate a null data packet (NDP) feedback report procedure; and
circuitry, which, in operation, processes the first frame, wherein the first frame comprises a first field which indicates intended type of NDP feedback report procedure.

10. The peer communication apparatus according to claim 9, wherein the first field of the first frame indicates that a frame of the peer communication apparatus and a second frame of the communication apparatuses are to be simultaneously transmitted, the first frame comprising a second field indicating an intended manner to assign a plurality of tones to one or more basic service sets (BSSs).

11. The peer communication apparatus according to claim 10, wherein the circuitry, in operation, generate a second frame to solicit a NDP feedback report.

12. The peer communication apparatus according to claim 11, wherein the second frame comprises a first field indicating an alignment of the NDP feedback report.

13. The peer communication apparatus according to claim 11, wherein the second frame comprises a second field indicating an index of tones assigned to one or more BSSs.

14. The peer communication apparatus according to claim 9, wherein, prior to the receipt of the first frame, the circuity, which, in operation, receives a coordination frame indicating a range of identifiers of intended communication apparatuses corresponding to one or more BSSs from the communication apparatus.

15. The peer communication apparatus according to claim 10, wherein the plurality of tones assigned to an intended communication apparatus in one of the one or more BSSs belongs to one or more 20 MHz frequency segments.

16. The peer communication apparatus according to claim 11, wherein, when the second frame is suitable to be transmitted to one or more intended communication apparatuses associated with the peer communication apparatus, without the receipt of the first frame, the second frame is received to solicit the NDP feedback report from the one or more intended communication apparatuses.

17. A communication method comprising:
generating a first frame to initiate a null data packet (NDP) feedback report procedure, wherein the first frame comprises a first field indicating an intended type of NDP feedback report procedure; and
transmitting the first frame to one or more peer communication apparatuses.
